(19) United States
(12) Patent Application Publication
(10) Pub. No.: US 2015/0311827 A1
(43) Pub. Date: Oct. 29, 2015

(54) Negentropic method and apparatus to generate usable work while reconditioning the energy source using electromagnetic energy waves

(71) Applicant: Victor M. Villalobos, (US)

(72) Inventor: Victor M. Villalobos, (US)

(21) Appl. No.: 14/120,129

(22) Filed: Apr. 28, 2014

(51) Int. Cl. H02N 11/00; H02J 5/00; H02J 7/02

(52) U.S. Cl. CPC H02N 11/008; H02J 7/025; H02J 5/005; Y10S 74/09

(57) ABSTRACT

The patent describes the entropic methods and apparatus of electromagnetic high frequency wave generator systems which convert electrical energy into magnetic energy waves and back which generates usable work as electrical potential. The patent primarily delves into the method and apparatus needed to extract Cold potential electromagnetic energy waves by using electromagnetic wave converters units which allow the extraction of work as net zero energy change process while simultaneously re-conditioning the energy source(s) electrical potential using a reversible net zero entropy change circuit without violating the Second law of Thermodynamics.

### RELATED DOCUMENTS

The present application is a continuation of filing Ser. No. 61/966,525, “Method and Apparatus for generating usable work while reconditioning the energy source at high frequency” dated Feb. 25, 2014 and

“Method and Apparatus to Generate Usable Work Potential while Reconditioning the Energy Source using Electromagnetic Energy Waves ” with a filing Ser. No. 61/995,303 with a date of deposit of Apr. 7, 2014 .

### BRIEF DESCRIPTION OF THE NEW ART

This patent refers to an entropic Cold potential extraction apparatus and method to extract usable work in the form of cold electrical potential which uses Maxwell's Displacement current theories where electrical potential is produced as a net zero energy change work process which uses high frequency electromagnetic energy waves generated from electrical energy.

The method uses scalable novice non-polluting methods of extracting usable potential from electrical DC/AC sources to produce charge potential capacity which generates electrical potential which can be used for doing usable work while simultaneously conditioning the potential to re-charge the originating energy source as a net zero entropy change system.

The patent keys on the facts that:

(a) Cold potential electromagnetic energy (EM)waves are generated by accelerating electrical particles in an oscillating electrical field in series with a capacitor and inductor (primary coil of transformer) which inherently exhibits a self-contained potential reconditioning property which recovers the electrical potential to the source (main disclosure of patent). This occurs while simultaneously exporting a time-varying inductive changing magnetic energy wave via the primary coil inductor member to the secondary inductor coil of a transformer. The effect exists whether the oscillation is at resonant, non-resonant or near resonant oscillating frequencies.

And (b), the electrical transformer when exposed to cold potential time-varying inductive magnetic Displacement currents becomes a self-sustaining electrical generator as per Faraday and Lenz' law of Self-inductance or also known as Mutual inductance (where an electric field (E) always accompanies a moving magnetic field, just as a magnetic field (H) accompanies a moving electric field),

The secondary coil inductor member of the same electrical transformer operating in a dual role as an oscillating source and an inductor member and still operating under the cold Displacement currents mode (as predicted by Maxwell) in series with a secondary capacitor and forming an (LC) circuit when exposed to a changing magnetic field wave will create a pairing time-varying electric field wave which gains electrical potential for the circuit and thus the electrical transformer becomes a self-sustaining electrical generator .

It is relatively well known that Electromagnetic energy waves(EM) are formed when an electrical particle is accelerated in an electric field, what is novice in the patent is that the cold potential EM waves generated from an oscillating source in series with an LC have a self-conditioning mechanism where the electrical potential is reconditioned and reclaimed by the source while magnetic energy waves are inductively radiated via the inductor member to regenerate a new complete electromagnetic EM wave which includes additional electrical potential which can be used to do useful work thus the electrical transformer becomes a self-replenishing generator of electrical potential.

In the 1800's Maxwell predicted and recognized in the Fourth of his famous four electromagnetic equations of the existence of two special types of current in circuits, that is hot current for steady state non time-varying fields (known as Ohm's current) circuits and Displacement cold currents which are produced by capacitors in a high frequency AC environment.

Displacement currents are cold nature wave-like currents generated by oscillating sources in series with capacitor circuits which generate time-varying fields current aspects (as opposed to hot current as defined by Ohm's Law). The cold current waves are able to carry energy wave properties and are produced by capacitors exposed to an oscillating energy source. The cold Displacement current as defined by Maxwell's Fourth equation (204) is practiced under this patent as an alternating cold energy wave which eliminates the hot current amps concept practiced under the Ohm's law thus eliminating the destruction of the electrical dipole of the battery.

Electromagnetic energy waves by default produce Displacement current waves and under a mutual synergistic coexistence where the electromagnetic energy cannot exist without Displacement current waves and Displacement current waves thus must exist as a byproduct for the production of electromagnetic energy waves.

The herein process of this patent is reversible and Negentropic in nature as it uses electromagnetic energy waves oscillating at high frequencies obtained by converting the DC or AC electrical energy to electro-magnetic energy waves at different frequencies to produce usable cold current potential which can then be converted back to DC potential and thus allowing for the reclamation of the same energy for re-use.

This patent points out the inefficient aspects of our present electrical energy utilization methods which only uses electrical energy in steady state circuits which “electrically shorts” the sources to produce an eminent discharge of the source.

Electrical energy today is being consumed and being miss-applied under the belief that electrical energy is a complete energy when in reality electrical energy is only half of the more complete energy picture which is contrary to the electromagnetic energy waves which is clearly a more complete energy application. Without a doubt in terms of efficiency, electrical energy is more efficient when first converted to electromagnetic energy which allows its reclamation of its potential and to be stored back as electrical energy.

This patent discloses the knowledge and teachings of a negentropic method and apparatus to utilize electrical energy efficiently and promotes efficient methods to obtain usable work from electromagnetic energy waves which transmits energy efficiently and which can be recovered after its use as a function of using the electrical and the magnetic field aspects and the properties of the classical electromagnetic energy waves (as predicted by Maxwell in the 1800's).

An electromagnetic energy wave can be produced by the oscillating or accelerating of an electrical charge with a LC circuit in series eliminates Ohm's hot current and evokes the generation of cold Displacement current as predicted by Maxwell Four equation (204). The series LC circuit can be further supplemented with secondary parallel LC tank circuit.

As part of the generation of electromagnetic energy waves and by default, the formation of electromagnetic energy wave potential mechanism itself contains a potential conditioning feature which reconditions the electrical potential for re-use. This is one of the most important novel claims of this patent.
A secondary property of electromagnetic energy waves potential when used with a series LC circuit, again by default, the LC circuit produces a dynamic cold “charge potential ” in lieu of the “hot power” that we know today as produced “by hot currents”, this potential is magnetic in nature and it is radiated via the inductor member. The radiant cold potential magnetic produced can be used to charge batteries while powering sources such as lights, electric motors or induction heater systems.
The Displacement current can be defined as the cold current produced by capacitors when exposed to high frequency oscillating AC potential which “cancels out the net current” thus eliminating the electrical hot Ohm's current of the circuit.

The Cold potential method using LC circuits in series which produces cold current which can deliver usable work in the form of EM energy waves magnetic energy while oscillating at high frequency without resistance. The process defuses the need for high hot current for delivering power out created by the Ohm's Law instead the circuit accumulates a “charge potential” to charge the batteries while simultaneously delivers excess kinetic energy to the inductor in the form of an alternating magnetic field (as a method of balancing the internal kinetic energy) which produces a net zero energy change work method using alternating “positive work” and “negative work” to export usable work.

The cold method circuit thus becomes a “charge potential radiating source” limited only by the “frequency of the process” and simultaneously a “work potential source” which re-conditions the potential of the energy source. Essentially, an oscillating energy source in series with an LC will produce electromagnetic energy waves, the oscillating circuit will export the magnetic energy via the inductor member to do useful work like charging batteries or driving an electrical loads while reconditioning the electric potential with the right polarity (electrical and magnetic polarity) for storage and re-use of the electrical energy.

Electromagnetic energy waves, in the purest sense are a pure sine wave inversion produced by oscillating a DC voltage source and being switched across a load using an H-bridge full bridge inverter device or equal device which transforms DC to AC with minimum overhead in series with an LC circuit.
The DC voltage needs can be boosted from the DC source potential to higher potential level, this can be accomplished either before the AC stage by using a DC-DC boost converter, or after the AC stage by using an electrical transformer (generally ferrite core transformer designed for high frequency).
As a source of energy, Electromagnetic energy(EM) in the form of waves is a more complete more manageable energy form and it offers several benefits not offered by using electrical energy alone such as the fact that electromagnetic energy can be transmitted without “connectivity resistance” and thus eliminate the wire resistance when transmitted as well as the fact that electromagnetic energy waves allow for the electrical potential generation thru the use of an electrical transformer and a self-reclamation feature of the EM energy back into electrical energy sources.
Another important benefit of the disclosed methods is that an electrical transformer when powered by electromagnetic energy waves becomes a three channel potential router device which will produce amplification of the voltage potential at two ports (output across both the primary and secondary coil in series) while the transformer maintains the integrity of the system to maintain a pure entropic circuit.
The patent in its main embodiment shows uses two electromagnetic wave convertors units back to back as a pair supplementing each other but contemplates the use of more pairs(in parallel or series) for larger energy applications which may require a greater energy output.
The basic cold potential apparatus to practice the art is shown as FIG. 1D as the main embodiment as a negentropic engine that can generate electromagnetic energy waves in the form of inductive magnetic energy to fuel itself.

Once electrical potential is converted to “wave energy” in the form of electromagnetic energy waves, the waves energy operates like quantum energy packs and behave differently under another a supplemental set of electromagnetic non-ohmnic rules where the frequency increases the potential content of the wave as predicted by Planck in the 1800's.

Planck's most significant event was the discovery that electro-magnetic waves energy is proportional to the frequency thus the energy content can be changed by just changing the frequency which changes the wavelength of the wave which changes the relative content of its circuit energy.

The electrical transformer becomes an electrical generator which contributes to the potential gain when exposed to high frequency cold potential electromagnetic energy waves. The transformer becomes an electrical generators of electrical potential when exposed to electromagnetic energy waves as a function of the mutual induction developed as well as an electromagnetic energy wave routing device acting as a three prong device which splits the received electromagnetic wave energy in two directions: (a) from primary coil to secondary coil(as normal) and (b) using the primary and secondary coil together as a connection combination. The transformer plays a major dual role of maintaining the entropy integrity “closed loop” while delivering “usable work” to the outside world.

The basic electromagnetic energy wave converter is made of a DC source oscillating at high frequency connected in series with an LC circuit with an electrical transformer to generate electrical potential thus converting the electrical energy into electromagnetic energy waves and back to recover the electrical potential which can be used to charge the originating DC energy source.
Electromagnetic energy waves as produced by LC circuits operate in the form of an oscillating high frequency AC circuit are cold in nature and “cancel out the net produced electrical hot Ohm's current” of the circuit thus producing cold potential Displacement current.
This patent relates methods and devices required to utilize and extract usable “cold potential” as electrical potential from both DC and AC electrical sources using a reversible net zero energy work process which maintains the integrity of a net zero entropy change circuit .
Major aspects of the Cold Potential Technology

Cold potential technology uses electromagnetic wave theory as predicted by Poynting, Maxwell, De Broiled and others in the 1800's, Oliver Heaviside in 1900's and in modern times by the interpretation of Quantum energy Principles by Albert Einstein which defined that the fabric of energy as being made out of “electric and magnetic field waves” and where the transmission of energy follows Poynting vector theory for electro-magnetic energy transmission.

As predicted by the Poynting Vector theory and revised by Oliver Heaviside, an electro-magnetic energy transmission thru any medium only requires “an electro-magnetic funnel” made out of the geometry formed by the “intersecting common points between the electric and magnetic flux vectors” motivated by a potential difference between the source and the load. The electrical wire conductors become the electro-magnetic markers of the path but not the medium.

Based on the Poynting vector theory, electromagnetic energy waves do not flow thru the wires like electrical circuits do and thus wires only serve to guide the electro-magnetic energy wave from the source to the load at lightning speed. An LC circuit, using a capacitor and inductor and especially the capacitor with its non-contacting parallel plates fulfills this theory in the best manner.

For the cold method the resonance frequency and the proper design of the capacitor and the transformer members requires for resonant frequency to be obtained as close as possible and while resonance is not as critical as the need to size the capacitor to be large enough to store as much energy as possible for the application and still perform under an appropriate operating range frequency. Thus the capacitor must be sized for voltage and for maximum storage to deliver the “charge potential” required while the capacitor size must account for a free oscillator operation including a minimum amount of resistance feedback from the transformer side.

An electromagnetic circuit in this patent refers to “an alternating source” with at least one LC circuit in series motivating an electrical transformer to convert electrical potential to electromagnetic energy waves.

The Cold Potential process generator presented in this patent uses at least one electromagnetic circuit but preferably two electromagnetic units back to back which oscillate at different frequencies while driving an electrical load.

Based on classical electrodynamics wave theory, the production of electro-magnetic energy waves occurs in terms of the movement and acceleration of electrical charges, in line with quantum theory, electromagnetic energy waves are produced and based on the idea that the subatomic particles of which matter is composed can only occupy certain “fixed energy levels”. Similarly in an electrical circuit, when electrical energy pulses are injected into a circuit, an electromagnetic energy wave is released as a result of the forced change from a higher to a lower energy state. Left to itself, matter and electrical energy will always try to reach its lowest level of energy.

Electromagnetic energy waves are produced when an electrical charge is accelerated and elevated to a higher potential and then released where it drops to a lower potential level naturally, if this is done systematically at high frequencies in series with an LC circuit electromagnetic energy waves are produced.

The process gathers potential from a continually internal kinetic energy gaining process as a function of the electrical and magnetic field aggregation produced by an oscillating energy source using an LC circuit in series at high frequency. Thus the aggregation of Charge potential occurs and is obtained from electromagnetic energy waves naturally and it can be used and re-used to generate work potential without pollution to the environment.

While it is true that static magnetic fields can't do work directly, the rate of change of current produced by time varying magnetic field certainly is what gets it translated into usable work as a function of “positive and negative work” alternating. This occurs as a function of the inductor elements when exposed to alternating electromagnetic energy waves which produces “positive work” using energy from the circuit and “negative work” which nets a zero energy change back to the circuit, this exchange which occurs at the rate of the frequency produces the net zero energy change work process which does use “potential” from the source. This fact combined with the knowledge that the oscillator wave-like current capacitor circuit operating as time-varying fields containing “time-varying rate of current” do not waste energy in the form of ohmnic hot current makes it an ideal and efficient method of utilizing electromagnetic energy waves to do usable work.

Cold potential methodology is based on quantum theory and it does not violate the physical laws such as the Universal Conservation of energy, Newton's Law of motion or the Laws of Thermodynamics because it is only a potential conversion method. The technology as described offers distinct non-polluting characteristics and many “features and benefits” to our society not available in any other manner.

### Cold Potential Electromagnetic Energy Transmission

The cold potential energy transmission circuit uses electromagnetic technology to transmit the energy like an antenna over the air medium at close by using the capacitor to store electrical energy intermittently (between capacitor plates) thus one plate essentially becomes an antenna (capacitor line) and a secondary plate becomes the ground and where the energy routing is defined by the “geometry” of the points of intersection between the electric field and the magnetic field. The changing electric-creates-magnetic and changing magnetic-creates-electric effects make possible the production of electromagnetic energy waves (radio waves). These waves are emitted by one side of the capacitor as the oscillating antenna plate (antenna) to the other (ground) and in essence, the battery source creates a potential differential that repeatedly reverses polarity at high frequency thus creating the electromagnetic energy wave.

The capacitor's internal antenna plate rapidly oscillates between + and − creating a rapidly-changing electric field. That rapidly-changing electric field (which is vertical) creates a rapidly-changing magnetic field (which is horizontal and “wrapped around” the antenna member). The magnetic field in turn creates an electric field which reinforces the existing electric field. Because of this reinforcement, the strength of the electric field apart from the antenna plate is much greater than it would be without this reinforcement.

### The Negentropic Features and the Second Law of Thermodynamics

It is known that all thermodynamic processes entail spatial redistributions of internal energies, namely, the spatial spreading of energy. Thus, entropy can be viewed as a spreading energy function with a symbol S appropriately standing for spreading. Energy spreading generally entails energy exchanges processes among molecules, among electric and magnetic fields including radiation, neutrinos, and the like.

The Second law of thermodynamics states that the entropy of an isolated reversible system never decreases because an isolated system always evolves towards a finite thermodynamic equilibrium.

Based on thermodynamics, any closed contained repetitive reversible entropic process which does not lose entropy to the surroundings can be executed without violating the Second law of thermodynamics. This occurs because the net entropy change of a reversible process is then zero as ΔS (Entropy total)=0.

In this patent, the electromagnetic energy wave converter presented contains at least one LC circuit operating at a certain AC frequency as a net zero entropy change closed system where there is not mass, energy or entropy that escapes. The excess kinetic energy produced is passed as an alternating magnetic induction wave to the primary inductor element of the circuit and is transmitted to the load generally via a secondary inductor where the generated magnetic field penetrates the primary and secondary inductor as mutual induction in an alternation fashion performing both “negative work” and “positive work” once per cycle producing a net zero energy change work process (See FIG. 1A and 1B) where the primary inductor member acts like a “magnetic induction membrane” with zero net energy usage.

Thus defining a method of generating usable work which uses an alternating action of the alternating source that do “positive work” and “negative work” in an alternating mode which utilizes the explicit introduction of time as a time lapsed-structure in the form of frequency periods for producing a net zero energy usage work process where the net result of the “energy used” and “energy given back” nets a zero change of energy .

Thus the reversible process which recovers the electric potential from the electromagnetic energy waves and vice-versa while exporting magnetic potential doing usable work as an isolated and reversible process which qualifies as a quasistatic or reversible process where not mass, energy or entropy leaves or enters the system thus can be executed without violating the laws of Thermodynamics.

Under the principles of Thermodynamics and Entropy from an internal entropic system perspective when dealing within a close alternating reversible process any work produced by a cold process which generates Displacement currents become an energy transactions where mass is not exchanged or lost, where the entropy and the energy of the system stays constant and its entropy does not change.

The Electromagnetic energy waves convertors units presented in this patent operate as one closed loop alternating reversible negentropic engine system which can be defined as a cyclic repetitive reversible process and a system that, at all times, can be treated as being at a uniform state. Energy is transformed from electrical energy to electromagnetic energy wave's form and back, this transformation is totally reversible and repetitive at high frequency (50 hertz or to 100 Kilohertz or more) without changing its total entropy or discharging its energy source.

The closed process being the conversion from static electrical energy to oscillating electromagnetic energy waves potential and back is a type of Carnot cycle where the energy flow from the static potential source reservoir to the oscillating potential source with an LC circuit which represents an increase in entropy with a work output and a method to continue the process .

Because the process is continued using constant energy where it is internally re-captured and stored in a secondary battery without losing mass, the process is then reversed producing a decrease in entropy that zeroes the total net entropy of the cycle. By operating in a circular mode and return to the initial starting state, the total net entropy change is always zero, ΔS (Entropy total)=0, as a function of the process being reversible and repetitive.

Thus as predicted by the Entropy law, usable work can be extracted from an alternating reversible entropic engine without violating the laws of Thermodynamics where all is required is two functions that change the energy's form back and forth between two states which can be described as:

The first entity receiving the energy in form A, and changes it into form B, doing work, but also feeds the form B energy to the second entity. The second entity changes the B-energy back to form A, doing work, but then feeds this A-energy back to the first entity as a continuing cycle. If this is done without “leaking” any of the energy from the process as demonstrated by FIG. 11A and 11B , one could simply create work from any charge of energy on a cyclical repetitive basis because the total net entropy change is zero and thus usable work can be obtained from the circuit without discharging of the energy sources ( as net zero energy work process) and without violating the Second law of thermodynamics.

### SUMMARY OF THE INVENTION

According to the attached embodiments, a negentropic method and apparatus is provided which comprises:

The patent relates to the methods and apparatus to generate usable work using electromagnetic wave energy obtained from electric energy which allows the conditioning and reclaiming of the electrical potential for re-use by the process and to maintain the energy source recharged as a net zero entropy change process which does not violate the Second law of thermodynamics.

The electromagnetic energy waves can be obtained from alternating electrical energy by using LC circuits in series. The method uses simple primary electromagnetic links circuits(EM Links), as shown in FIG. 1A, is made of an electrical alternating source in series with an LC circuit as a unitary circuit to form other more complex EM circuits. Electromagnetic energy waves convertor units as shown in FIG. 1 E, as an example, is made out of several EM links working together, more complex circuits can be built using several electromagnetic energy waves convertor units by using EM links.

According to the patent , our present utilization methods of electrical energy is incomplete and wasteful, as “hot current” is created to produce power which consumes the source by extracting potential in a shorting method which quickly consumes the source.

(a) According to the patent, electrical potential can be borrowed to perform work without consumption and without violating the Laws of Thermodynamics.

(b) According to the patent, Electrical energy once converted into electromagnetic energy waves holds a “charging potential capacity” which can be used to produce work as well as can be recovered to recharge the energy source.

(c) According to the patent, a Cold potential electromagnetic energy wave is-can be generated as a “time-varying rate of cumene” operating at high frequency which can be converted into usable work.

(d) According to the patent, the cold potential generator generates an electromagnetic energy wave which simultaneously recovers the electrical energy portion potential which is recovered by the LC circuit and exports a new electromagnetic energy wave via the inductor member to do useful work like charging batteries as well as motivating inductor loads.

(e) According to the patent, the cold potential convertor uses an electrical

RF transformer to generate potential as “a mutual inductance” generator with one input channel and two output channels respectively to power the load and a channel to recondition the electrical DC source.

(f) According to the patent, usable work is produced as net zero energy change process which produces alternating “positive work” and “negative work” thus not consuming the sources potential.

(g) According to the patent, the overall output of the cold potential convertor produces a “cold charging capacity” as is a function of the working frequencies, the capacitor size and the voltage of the battery bank.

(h) According to the patent, the term “cold potential” is born from the fact that the circuit generates cold Displacement currents where the “net current” of the process at the end of each full frequency cycle is cancelled out (thus eliminating the destruction of the electro-chemical potential and thus avoiding the discharging of the source).

(i) According to the patent, capacitors by themselves when driven by AC oscillating potential at high frequency convert the polarity of its electric field while acting as a permanent energy storage device.

(j) According to the patent, inductors by themselves when driven by AC oscillating potential convert the magnetic energy polarity while acting as a temporary energy storage device.

(k) According to the patent, the total energy output of the convertor circuits converts into Charging potential capacity as a direct function of the square value of the charge of the source (Q) and is an indirect function to the capacitance (C) used and a direct function of the frequency.

(l) According to the patent, the rate of electrical power delivered by the cold potential primary LC circuit (battery, inductor and capacitor) network is a function of the Q value, the C capacitance and the rate of conversion of electric energy into magnetic energy back into electrical potential at a frequency (w).

Note: This patent defines capacitors as AC capacitors to include super-capacitors, ultra-capacitors and pseudo-capacitors that can be used but excludes any DC capacitors such as electrolytic capacitors type that are unable to be discharged and recharged with a reversed polarity potential. The AC capacitor chosen must be fast enough to charge and discharge at high frequency rates.

### BACKGROUND OF THE INVENTION

Electrical potential “consumption” as a whole science today is not a very common subject and it is one of the least available notions in the physics science world today. Our scientific society accepts, electrical consumption.

While our society consumes millions of trillions of watts of electrical potential daily, the physical laws fail to treat, clarify or explain the mechanisms attached to electrical consumption and shine by their very absence and possibly stand alone as the most prevalent least discussed inadequacies of our sciences in our universities and physics circles today.

At this time, common understanding of how electrical potential gets consumed ranges from cloudy to non-existent, notions or elementary rules about reconditioning for re-utilization of the potential for electrical devices like electrical motors and other electrical device are absent and non-existent in our sciences. Potential extraction, preservation, consumption and the reconditioning of electrical potential as electromagnetic energy waves are the main subjects of this patent.

Our present formal understanding of electrical potential utilization methods have been guided primarily by four main theories developed in the 1800's, the Maxwell equations, Faraday's Law, Lenz Law and the Ampère-Maxwell Law. These theories pretty much in totality illustrate the “electromagnetic field” and the potential developed by the actions of an electro-magnetic field stored in motion thru air and other metal conductors. Faraday's Law discovered the rules of “a changing magnetic field which creates an electric field”, this is the principle behind the electric generator while Ampere's Law states the rules of ‘a changing electric field creates a magnetic field’. Thus, this law can be applied to generate a magnetic field and run an electric motor. Today these laws are the closest description available to describe the utilization of the electrical and magnetic field both for generation as well as electric motor usage. However, the actual mechanics and details of potential consumption are absent in explanation and thus electrical potential and millions tons of polluting oil base fuels are burned daily.

In the past, electrically charged objects were thought to be made of two unrelated types of fields and only associated by their charge property, the electric field produced when the charge is stationary with respect to an observer measuring the properties of the charge, and a magnetic field (as well as an electric field) created when the charge moves (creating an electric current) with respect to the observer, this field can be discharged and the “potential” is forever consumed when utilized.

Until 1831, the Electrical(H) and the Magnetic field(B) had been viewed as unrelated phenomena. In 1831, Michael Faraday made the discovery that time-varying magnetic fields could induce electric currents and then, in 1864, James Clerk Maxwell published his famous paper on a dynamical theory of the electromagnetic field.
Today, we understand clearly that the electric field and the magnetic field are one integrated whole theme and we recognize it as the electromagnetic vector made out of two brother elements, the electric field and the magnetic field (as electrical energy flux) acting as one agent is a dynamic entity. The process and mechanics of transferring of energy was later described by the Poynting Vector Theorem which identified the basics for the transmission of energy.
Electromagnetic energy has two main constituents, the electric field and the magnetic field which represent the minimum requirements for the transmission of energy.

With certainty, we know today that the Electric field (B) controls the direction of propagation and produces the Magnetic field(H) which stores energy in the form of electro-magnetic flux. Today we also know that the electromagnetic field vector effect is produced mainly from a given charge distribution (such as a potential from a battery), as well as the metallic objects in the vicinity within this field will experience an imposed force(electromagnetic current force).

In 1923 De Broglie's proposed the wave nature of electrons and this was experimentally confirmed in 1927. De Broglie's theory of “electron matter waves” was later used by Schrodinger, Dirac, Milo Wolff(contemporary) and others to develop today's clear known relationship between energy and electro-magnetic wave concepts.

This patent recognizes that all the natural laws of electromagnetic energy wave usage converge into the Entropic concepts of Camot and Clausius which cover the electromagnetic energy wave theory where energy waves are found embedded in the electromagnetic wave structure of electrical and magnetic fields as envisioned by Poynting, De Broglie, and Schrodinger.

The significance of the Poynting vector theory indicates that electro-magnetic waves can carry energy (the capacity to do work) through space as radiant energy. Because of Quantum physics, radiant energy resides in a dual state which can be viewed as the energy stored in the photons and it can also be an energy wave which carries energy in the oscillating magnetic and electrical field produced by the wave-like motion of the electromagnetic wave.

At any point in space, the flow of energy can be described by a power density vector P, which specifies both the power density in Watts per square meter, and the direction of flow. The vector P is called the Poynting vector, and is a simple cross product of electric and magnetic field vectors, as P=E×H.

The second most significant event is the discovery that electro-magnetic waves energy can be increased by changing the frequency, this was predicted by Planck .The relationship between frequency and energy applies only to electro-magnetic waves, and can only be understood in terms of the ‘wave-particle duality’ of light(radiant energy). The constant of proportionality was worked by Planck, so is known as Planck's constant, and is denoted in Physics by the letter h. The formula (E=hf) gives the energy of a photon in Joules for a wave of frequency (f)Hertz.

As deduced by Einstein's Quantum theory, of equal or more significance is the fact that in modem times within the development of the wave-energy concepts is the structure known today as the Frequency-Mass-Energy concept which describes energy as related to the “relative motion of charged particles like waves” which carry energy. Today there is a fundamental common theoretical and mathematical unification of these two famous theories which have evolved. Today mass and energy are considered to be made up of electro-magnetic waves.

Thus in modern times, the concept of propagation of energy in the form of an electromagnetic wave as proposed by Maxwell and the Poynting vector theory is accepted and has been defined as the very fabric of the Universe as made of intertwined and intersecting electro-magnetic fields succeeding as waves within the medium. Today it is accepted that electromagnetic energy waves can be transmitted as a propagating wave thru almost any medium.

Thus, the electromagnetic field and its propagation may be viewed as a dynamic wave entity that causes self-induced charge waves and radiation of energy waves (radiating energy) while being moved by electro-magnetic forces which accelerates the charged particles produced by charged particles. These mutual interactions have being amply described by Maxwell's equation and the Lorentz force law.

The cold method process, in this patent, represents a reversible entropic process. The initial analysis which led to the concept of entropy was started by the French mathematician Lazare Carnot who around the year1803 which culminated with the now known Carnot cycle. The ultimate concept of entropy was completed by Rudolf Claudius's around 1880's as a study related to the Carnot cycle. Ultimate Schrodinger expanded the entropy concepts to indicate the relationship of Entropy to the very life concepts. Entropy relates to the “order” and “disorder” of the Universe as a main fuel for the “life” concepts of our world.

Energy transfer medium

The classical electromagnetic theory establishes that energy would flow through any medium of intersecting electric and magnetic fields as long as the fields are not parallel to one another. There is not requirement for the space to be filled with magnetic or non-magnetic material and in fact it may be empty space but it must contain intersecting electric and magnetic flux vectors which are the primary constituents of the electro-magnetic canopy entity where an energy flux vector is developed. Energy flux density (energy per area per time) is described by the Poynting vector equation,

$$S = \frac{1}{μ} E \times B ,$$

where
E=electric field intensity [V/m
B=magnetic flux density [T]
μ=permeability of the medium [H/m]
This is known as the Poynting vector in honor of J. H. Poynting (1852-1914) who developed the theory.

This vector product represents the angle between the field vectors E and B. The energy flux vector represents power per area transmitted by the electromagnetic field. It is worth noting that this description of energy transfer applies across the universe where the known electromagnetic spectrum exists and indirectly sets the stage for the idea of the “quantum” waves which includes generically light energy.

In the classical description of the electromagnetic energy flux wave, the energy flux wave contains the electric and magnetic fields which are perpendicular to each other and both are also perpendicular to the wave's direction of propagation. The electric and magnetic fields store energy and together as the energy flux are responsible for the transmission of energy. It is important to note that the Poynting vector does not depend on or requires an “electrical current” to transmit energy, it is also important to note that there is no requirement “to have a complete metallic conducting loop” for energy transfers to take place. The only requirement for proper energy transfer is an energy flux path woven (electro-magnetic funnel) from the electromagnetic electric and magnetic flux fields. In other words, the use of metallic conductors only serve the function of physically supporting the intercepting points of the electric and magnetic flux fields so that the energy flux path can exists.

Hot current (Ohm's current) versus capacitors Displacement cold current
These are the original Maxwell's famous four equations developed in the 1800's:

$$\begin{matrix}▽ \cdot E = \frac{ρ}{{ε}_{0}} , & ( 200 ) \\ ▽ \cdot B = 0 , & ( 201 ) \\ ▽ \cdot E = - \frac{\partial B}{\partial t} , & ( 202 ) \\ ▽ \cdot B = {μ}_{0} j . & ( 203 )\end{matrix}$$

The original Fourth equation Eq. 203 (above) was originally written as a reference to “real current” only and represented by Ohm's Law(I=V/R), it was later redefined by Maxwell to include “the displacement or capacitor's current” as follows:

$$▽ \times B = {μ}_{0} j + {ε}_{0} {μ}_{0} \frac{\partial E}{\partial t} ; \qquad ( 204 )$$

The extra term added to Eq. 203 is represented-by in Eq. 204 which establishes a relationship with the “rate of energy change” (dE/dt) which is called the displacement current (this name was invented by Maxwell). The displacement current is associated with the generation of magnetic fields by time-varying electric fields cold in nature and thus more efficient. Maxwell came up with this rather curious name because of his original initial ideas regarding electric and magnetic fields; however, current in this case is a clear misnomer because Displacement current is not a current as we know it today. Displacement current produces “Charging potential”. Maxwell later did recognized that his Fourth equation(203) was faulty as it lacked an explanation for the lack ohm like current when capacitors were exposed to high frequency AC, his original equations failed to link the time-varying electromagnetic fields which can induce conversely produce electric fields and magnetic fields.

Therefore, Maxwell's Fourth equation was later revised today to incorporate as an aggregate definition for the “Displacement current” produced by the magnetic field in capacitors. Displacement current (cold or capacitor's current) is referred and only exists when the electric field is changing in capacitors.

Conduction current (Ohm's current) refers to the current produced by “hard conductor's connectivity” and it follows Ohm's Law. Hard connectivity is not necessary for the transfer of energy and it produces heat which wastes the energy. The Displacement current is generated by and it is associated with the generation of magnetic fields by time-varying electric fields and it does not follow Ohm's Law.

The Displacement current can be better expressed as Charging potential(E) per cycle produced by the changing electric field between the capacitor plates. The charge Q (amps) on a capacitor of capacitance C(Farads) is Q(amps charge)=C(Farads)×V(Volts Charge on a Capacitor).

Where the Charge energy per cycle in the capacitor is:

$$= \frac{1}{2} {CV}^{2} .$$

The significance of the Displacement current is not related to hot current as we know it but it relates to the “amount of charge energy that the circuit can cycle for each wave time period” as a function of the capacitor storing energy and it relates to the “frequency” or how fast it can be cycled. Thus Displacement current is related to a Charge potential(E) output of circuit as defined by a cycling capacitor operating at a certain voltage and frequency as:

$$( E ) Charge potential = \frac{1}{2} * {CV}^{2} * freq ( in Hertz ) \qquad ( 206 )$$

Charge potential is a function of the frequency.

Displacement current theory thus refers to the Charge capacity(E) created by capacitors exposed to an alternating voltage source which are charged and discharged by an electric field potential at a high frequency. The electric field between the capacitors plates is changing in time as a function of the frequency producing a mutual induction and an equivalent magnetic field which balances the changing electric field. The referred Displacement current exists only when the electric field is changing and when the circuit is free to oscillate without resistance by having a capacitor in series eliminating the that hard metallic connectivity which “damps” the free oscillation of the circuit.

In reality a better explanation of Maxwell's Fourth equation (204) is to interpret it as an either A or B type current with an exclusionary definition property where one current type will exclude the other current thus Hot current excludes the existence of Cold current and vice-versa but both currents cannot exist simultaneously in the same wire while attached to the same source.

### Cold Potential Energy Transfer is a Kin of the Poynting Vector Theory

The cold potential method principal objective is to eliminate the “irritating action” of the electrical hot conduction currents produced by “direct shorting connectivity” which consumes electrical potential and the enhancement of the Displacement currents produced by the capacitor in the form of “cycled discharging currents” as a function of frequency.

The cold concept uses the Poynting theory to transmit energy, it eliminates “hot current” and replaces it with Displacement current where electromagnetic electric and magnetic fields form an energy “funnel” around a LC circuit which defines the new geometric envelope to transmit energy.

The Poynting vector theory is the key to the understanding of how energy is used and how energy in the form of a wave gets transmitted from an energy source to the load. It is important to note that the Poynting vector only defines the source as having “a wave source” and it implies the source being of an electromagnetic in nature, the Poynting vector theory and it “assumes” that the circuit would be free to oscillate.

The cold potential method brings into definition the method of producing an “electromagnetic wave source” which is free to oscillate by using an oscillating source in series with a capacitor as part of an LC circuit(radiant energy).

The cold potential method defines four energy elements: an electrical charge from an oscillating energy source , the cold current produced by capacitors, the oscillating electric field and the created magnetic field whose complex relationships are governed by the revised classical four equations (known as Maxwell's equations). These four elements conjugate to produce the elements required for its energy use and transfer. Work is produced as a byproduct by the high frequency acceleration of the electric particles in motion as produced by the electric field and magnetic field oscillations at high frequency.

Presently an electric field can be produced in two ways either (a) a charge separation furnished by the energy source(DC or AC) or (b) the electro-magnetic induction produced by the oscillation of the magnetic field around an electric field (like in electrical generators).

In the classical sense, the internal electric field is directed along the axis of the conductors and is responsible for accelerating of the charges producing a current. The total electromagnetic energy flux field is a combination of the electric flux field and magnetic flux field acting together in the space outside the conductors that carries the energy from the energy source to the load. Once both fields have connected perpendicular to each other, the energy travels establishes connectivity through space, perpendicular to both the electric field and the magnetic field, at the speed of light. Energy then is able to be transported from the energy source by entering the conductors of the load travelling in energy flux bridge-path following the path of least resistance but exclusively dictated by the geometry of the energy flux bridge.

### Metallic Conductivity is Not a Requirement for an Efficient Energy Transfer

In the purest sense, the Poynting vector theory does not require for conductors to have metallic conductivity, it only requires an electro-magnetic geometry path funnel for the energy flux which follows the electro-magnetic geometry canopy. Metallic conductors are only required to “mark the geometry” of the energy flux of how to go from the source to the load.

In the practical sense and in fact, “the hard conductivity” of conductors is actually counter producing to the transmission of electromagnetic energy because it puts in play the “resistance of the wire” creating the “conductive current” and in reality the resistance of the load and the conductor together acts as an indirect deterrent and destructor of the magnetic and electric field.
The cold potential method is based on the fact that the “capacitor” offers a bridge of conductivity path for the oscillating electric and magnetic fields which creates a different cold type of current(Displacement current) by using an LC circuit where energy can be transmitted without creating hot currents(Conduction currents).

### Electromagnetic Wave Momentum

Once the electromagnetic flux has been motivated to move, there is a mutually induction between the electric and the magnetic field that promotes the electromagnetic wave to stay in motion acting like a free-mass twirling in space and it is due to the fact that once one of the fields (magnetic or electric) starts changing in time (motivated by an initial impetus potential) such changes induces other changes in the other field which is also changing in time (because the field producing it is changing and is directly proportional to it). So, this mutually and simultaneous induction of the fields is what produces electromagnetic waves and can continue indefinitely as long as the electric field is sustained.

Magnetic energy fields are mainly the product of moving charges within inductors in an alternating fashion. From this observation it is important to see that because the charge (having an inherent electric field) moves in space and time (thereby changing the nature of the electric field), this changing electric field induces a magnetic field change. In a similar way, when a magnetic field is changing in space and time, it induces an electric field change to take place.

### Implied Inertial Mass Effect of Inductors

When all the electric-magnetic field waves and geometry elements of an inductor including the Frequency-Mass-Energy electromagnetics concepts are lumped into one number—the inductance, L (inductance) defines the ratio relationship between the voltage(electrical field) applied to an inductor and the resulting current flow can be expressed very simply as:

V=(−) L(di/dt) where (di/dt) is the rate of change of current and is related to the magnetic field wave oscillation which encompasses the frequency of electromagnetic waves.

A changing magnetic field wave creates an electric field wave and vice versa as per Lenz' law of Self-inductance or also known as Mutual inductance. This is the basis for powering transformers and electric power generation. If one coil of wire (or one electromagnet) is placed close to another, an increasing current flow is established in the first coil, which creates an increasing magnetic field.

The changing magnetic field as a magnetic flux creates an electric field electric flux directly in the wire (and in all other regions of space nearby). The amount of voltage generated is proportional to the total length of wire in all the loops and the magnitude of the magnetic field. Electric fields exist parallel to the conductor and the magnetic field exist perpendicular to it.
There are only two ways of creating an electric field from scratch. One way is to have separation of positive and negative charges, that's just what batteries do; the other way is to develop a changing magnetic field, as in the phenomenon of electro-magnetic induction.
Thus it is generally known today that an electrical potential is brought forward by two methods (a) DC batteries which separate potential charges and (b) by the electro-magnetic induction produced by inductors when exposed to an electrical potential wave which creates a differential between the magnetic field and the electric field across the inductor(motor) which promotes additional extra potential.

An LC circuit made up of an inductor and capacitor operating “in a quantum wave fashion” forms an energy flux geometry which promotes other electromagnetic events when exposed to an electromagnetic wave, as predicted by Schrodinger and others.

Quantum electromagnetic current waves are produced in LC circuits when exposed to an electrical potential field wave, thus electrical currents develop within an electrical field also create magnetic field waves which reinforce and promotes more currents to flow through a medium that holds an energy geometry path of its own (and it is not necessarily a hard metal conductor path).The cold potential principle only uses the energy flux geometry path formed by the fabric LC circuit woven by an electric flux path (not parallel) to a magnetic flux path to transfer the potential of the electromagnetic energy waves produced.

And in the form of a resonant or non-resonant circuit, the path is made out of an inductor, represented by the letter L, and a capacitor, represented by the letter C. When connected together an electric current can alternate between them at the circuit at resonant or near resonant frequency; however, for the cold potential method the resonance of the frequency is not a requirement . Since an LC circuit is nothing more than a harmonic oscillator where charge is the conjugate variable, the quantum mechanics solution is known exactly:

$$ω = \sqrt{\frac{1}{L C}}$$

where L is the inductance in Henries, C is the capacitance Farads The angular frequency Ω has units of radians per second. A capacitor stores energy in the electric field between the plates, which can be written as follows:

$$U = \frac{1}{2} {CV}^{2} = \frac{{Q}^{2}}{2 C} since C = \frac{Q}{V}$$

Likewise, an inductor stores energy in the magnetic field depending on the current, which can be written as follows:

$$U = \frac{1}{2} LI \text{?} = \frac{φ \text{?}}{\text{?} L} since φ = LI$$

$$\text{?} \text{indicates text missing or illegible when filed}$$

Using the charge as the variable, and magnetic field is proportionally related to the “momentum and inertia”, (due to the similarity to a mass on a spring) one can develop a Schrödinger equation due to its repeatability to describe the cyclical action having constant energy stored energy in the system(not shown).
The cold potential process uses an LC circuit in series configuration in an electric field oscillating medium as a method to create the Displacement current which produces a charging potential and an alternating differential electromagnetic energy flux wave.

The inductors themselves on their own can act as self-standing entities and exhibit an inertial mass behavior which produces a “potential”. This phenomenon is purely an electromagnetic wave event created and sustained by the magnetic flux fields give charged particles “a mass-acceleration energy similarity” from which we derive the concept of inertial mass accelerating which in turn produces an Emf electromagnetic force.

In an electromagnetic circuit operating at high frequency, the electro-magnetic work is produced by the “rate of change of the displacement current ” wave and it is indirectly produced by the dynamic fluctuation of the magnetic flux wave. A fluctuation of the magnetic field creates a fluctuation of the electrical field which creates a potential differential across the inductor which promotes electro-magnetic work to reconcile and balance the kinetic energy of the circuit.

This patent shows that “the rate of change of the displacement current” instead of the connectivity hot or Ohm's current (displacement current is produced by a time varying magnetic field) acts as a “differential potential electromagnetic wave” across the inductor producing an electrical flux change giving us electro-magnetic work in order to balance the kinetic energy of the circuit.

While it is true that static magnetic fields can't do work directly, the rate of change of current (produced by time varying magnetic field) certainly is what gets translated into work as we know, that the magnetic fields are highly responsive to the frequency and impedance changes thus affecting the electric fields in a mutual induction basis.

### Fundamental Concepts About the Negative-Positive Work Effect and Electrical Inertia as Related to Inductance and Faraday-Lenz Law

Inductance is the circuit parameter used to describe an inductor, symbolized by the letter L is measured in Henries, and it is generally physically described by a coiled wire symbol.

When an inductor is pulsed with an electrical potential pulse, it generates a voltage drop(work per unit charge) across the terminals of the inductor as a function of an electrical current increase where:

V=(−) L di/dt eq(1a)

where V is the measure voltage in volts, L in Henries and di is a change in current and dt as a change in t seconds time. Because 1/t, the definition of a period of time, is directly related to the frequency (Ω), it can be immediately implied that an induced voltage is a function of frequency and a period of time where the current is changing with time. From this relationship, it is very apparent that the induced voltage decreases as (di/dt) increases for a given L and as frequency (Ω) increases and vice-versa.

When analyzing an inductor electrically and particular the behavior and direction of current, certain Newtonian analogies become readily apparent, the current which represents the charge per unit time (di/dt) which behaves like the rate of change of the velocity of the charge where L is analogous to the common mass inertia. Thus (−di/dt) represents a rate of change of “negative current” that it is running against the regular flow of current from positive to negative. This represents an electrical inertia type of behavior just as a mechanical mass which has an inertia value proportional to L with inertia properties where the (−di/dt)^{z} the rate of change of current velocity becomes the acceleration of the current which is related to electrical power or potential which is in turn directly proportional by L and to the induced voltage and where R(resistance).

$$Electrical potential ( watts ) = \frac{{L}^{2}}{R} * {( ( neg ) di / dt )}^{2} \qquad Eq . 1 a$$

where Eq. 1a is analogous to Newton's equation, Force=mass*acceleration.

$$Inductor voltage ( force ) = \frac{{L}^{2}}{R} ( mass ) * ( neg ) {( di / dt )}^{2} = ( neg acceleration ) . \qquad Eq . 1 b$$

Thus generically, in an inductor any oscillation motion of the electric flux produces an equivalent magnetic flux as a function of the “charges accelerating inertial behavior” produced by the oscillations of the electric field. This acceleration produces a potential change which in turn produces a change in the Kinetic energy of the system to reconcile the energy bottom line of the circuit thus converting potential gained acceleration to work.

Thus Eq(1a) is analogous and corresponding to Newton's Second law of motion, where L has an inertia and acting as a mechanical mass , and where the inductor develops a resistance to any change in current magnitude with time, so the resulting induced voltage compares to a mechanical force and within a time frame an accelerated charge takes place where EMF of self -induction is set-up. Thus “induction” is the acceleration of a charge which creates a magnetic field change which provokes the electrical field to extract electrical potential. As per Newton's Laws of motion, we know that acceleration of any kind if in the presence of a mass produces a force doing work, where the work can be Positive or Negative as follows:

Positive Work=Force*distance=L(mass)*di/dt (pos. acceleration)*R(resistance) Eq(1c)

Negative Work=Force*distance=L(mass)*(−di/dt) (neg. acceleration or decelerating)*R(resistance). Eq(1d)

Thus an inductor, just like any accelerating mass, is able to do positive work or negative work, this occurs because the electrical current which produces electrical acceleration can behave like a negative or positive acceleration motion in the form of a differential electrical-magnetic wave operating at a frequency.

Thus LC circuits including capacitors and inductors working together when exposed to inductors AC waves will exhibit a mutual negative resistance which manifests itself in what would become a self-resonating circuit.

Usable work is produced as an external energy balancing effect which occurs as a natural means to reconcile the internal circuit kinetic energy

In classical terms, Work is defined as a transfer of energy between systems mediated by a force and where power is defined as the rate of work.

In electrical systems, electro-magnetic forces for inductive electrical motors are the result of exposure of induction forces to which causes indirect magnetic field changes(oscillations) and even when the magnetic field itself does not do work directly, instead the magnetic field produces an equal fluctuation of the electric field which in turn creates a potential differential which produces the electromagnetic forces exterior to the circuit, all part of the universe's energy-mass-wave electromagnetic fabric .
The fluctuation (differential wave) of the magnetic field is created by “an acceleration of the current”(wave) and the Inductor (L) inertial properties, this is the actual mechanics of the electromagnetic forces doing electromagnetic work.
The generated electromagnetic forces are analogous and generically similar with the mechanics of the forces at play as per Newton's Second Law of Motion which says that a mass particle when exposed to a force(F=mass*acceleration) will accelerate in the same direction as the force doing work thus doing “positive work” which becomes (W=mass*acceleration*displacement) and the work performed is a function and proportional to the product of force times displacement.
Within an electrical circuit just like a mechanical circuit, an accelerated force is either doing positive or negative work as a method for reconciling the Kinetic energy. In a physical (and electromagnetic sense), when a mass accelerates in an opposite direction as the originating force then the work becomes “negative work” thus (Negative Work=mass*negative acceleration*negative displacement).

The fundamental reaction of an accelerating charged particle is to reconcile the kinetic energy of the system by changing the magnetic field of the final inductor motor thus the indirect action of the electric field changes the magnetic field indirectly. The magnetic field and the acceleration have a direct and reverse action in that the charge is able to do positive or negative work against an inertial force which changes its speed and the energy content of its magnetic field and thus defining the primary function of the magnetic fields in nature which is to embrace and contain the potential energy of the moving electric field.

This is exactly what happens within an inductor electromagnetically, the input electrical positive potential in one direction produces a negative acceleration(rate of change of current) as a response in the opposite direction to adjust its kinetic energy. As demonstrated generically by the work-energy principle for which there are two generic solutions as follows:

(1) The first derivation describes the commonly known solution for Positive work which by definition uses the potential of the source to do work where both the applied force and the displacement and acceleration of the particle occur in the same direction, it is shown as:

Energy net=(W out)−(W in), (Positive work) where the (W out) is positive.

(2) The second derivation of the same shows the less known solution is related to a Negative resistance work effect which occurs in which the mass will accelerate in the “opposite direction to the force” as (neg)di/dt representing negative rate of change of current); therefore, the force still doing work but creating a negative displacement thus doing “negative work” because potential is never destroyed, the polarity of the magnetic field is dissimilar. This “negative work” is potential which can be aggregated to replenish the potential source and it can be represented as:

Energy net=(−W out)−(W in), eq.100 (Negative work)

Energy net=(neg)(Work out+Work in)

Note: In this solution (−W out) gets aggregated to the −(W in) as “negative work Negative potential” indicating that “Negative work” potential can be aggregated as a negative quantity and suggesting that “negative potential” can be converted into positive potential to re-power the potential source by re-polarizing of the magnetic field of the potential itself

Positive potential from the first half of a cycle will produce Positive work which causes the inductor to become “a positive magnetic energy source” which requires energy while on the second half of the cycle negative potential will produce Negative work which will cause the inductor to become “a positive magnetic energy source” which supplies energy. At the end of a full cycle, usable potential is produced externally to the inductor while internally to the circuit, internally to the circuit the work process becomes “a net zero energy charge work process”.
This interaction is produced between a charged particle and its surrounding magnetic field which corresponds to a positive energy gain or loss of acceleration and thus requires an adjustment in the energy(Kinetic energy) content as enforced by its magnetic field.
Thus within an inductor as the oscillating rate of change of current in the form of a wave occurs both positive and negative work is alternative done as a function of its magnetic field oscillating, thus energy from the magnetic field must be either adsorbed by doing positive work or energy is supplied when doing negative work. This alternating oscillating repetitive action creates a net zero energy change work process which does not consume potential from the energy source thus maintaining the entropy integrity of the circuit internally while exporting usable work externally to the load in the form of magnetic energy waves , this process is defined in this patent as the Negative-positive work effect.

### Fundamental Relationship Between Work and Kinetic Energy

The fundamental equation of all electromagnetic wave interactions and work is related to the differential in the energy content of the magnetic field of the inductor which produces a current as an indirect exchange of energy which changes the electric field thus generating forces doing work thru the use of LC in series devices.

Thus as the rate of current (time varying magnetic field) through the primary LC circuit is increased, “positive work” must be done to increase the energy content of its kinetic energy or vice-versa , as the rate of current through the same circuit is reduced, kinetic energy from the magnetic field must be adsorbed by doing “negative work”. The net effect of these forces is again described as the “induced emf”.
The action of slowing or increasing the acceleration of a particle produces an imbalance of potential manifests itself as a change of the magnetic field which in turn becomes electrical potential. Essentially the physical system (mechanical or electromagnetic) has to come up with an adjusting action by doing work(positive or negative) against a force to reconcile the kinetic energy content of its magnetic field created by a mass inertia of the inductor. This adjustment of energy is produced by a force (acting through a distance) which does work, generically this force can be negative or positive as a virtue of being an accelerating or decelerating inertial mass.
Thus positive or negative work alternating production thus become the fundamental basic electromagnetic operation within inductor devices and other devices when exposed to an alternating electrical wave where changes of its magnetic fields produce a fluctuating (wave like)exchange of energy through the forces generated by an electromagnetic inertia which changes the magnetic field.
Electromagnetic theory predicts that there will be a flow of energy through any place where electric and magnetic field waves both exist as long as they are not parallel to one another. The electromagnetic cold potential effect allows the transfer of energy which is produced as a function of the frequency (where the higher the frequency the higher the energy flux) of the electromagnetic wave and where wavelength is indirectly proportional to the frequency.

The Negative-positive work effect as described is in perfect harmony and correspondence with Faraday's Laws, Lenz's Law of induction and Newton's

Laws of motion and as to each other and there isn't any unreconciled potential generated by the re-polarization of the magnetic and electrical fields which causes any violation of the Universal Conservation of Energy laws.

Electric energy is converted into electromagnetic energy while simultaneously reconditioning the potential by using LC circuits (inductors and capacitors in series) with an oscillating source

A charged capacitor produces an electric field and a charged inductor coil produces a magnetic field. A charged capacitor and coil, mutually interconnected in series by a wire circuit alternately charge and discharge each other, producing electromagnetic radiation energy(radiant energy) caused by the lack of resistance. In the absence of resistance, the electromagnetic energy becomes magnetic energy wave able to do usable work.

Capacitors will “resist” passing zero frequency DC potential because they have to manage an internal dipole, inductors just like capacitors will not pass DC easily and inductors will generate a negative current wave reversing its magnetic field polarity after passing DC. A single inductor when energized with AC will create an electrical current (magnetic field wave) of the opposite polarity. Thus the inductor responds to AC by creating “a reactive magnetic resistance wave”.

An LC circuit (resonant or non-resonant) when exposed to a potential pulse will respond in two ways; (a) The inductor will “reverse” the polarity of the magnetic field but will leave the electric field the same polarity and (b) the capacitor will change the polarity of the electric field and will pass the magnetic field untouched. Thus both the inductor and the capacitor together as a LC circuit in series recondition the polarity of the electrical and magnetic potential thus recuperating the potential used to do work.

For our purposes is important to recognize that the fabric of the universe is made up of “dynamic waves and static dipoles”. Our universe much prefers to transfer energy in the form of waves and oscillating fields while another part of the universe likes the permanency of electromagnetic static dipoles. This is electromagnetic energy, the ultimate Ying-yang of the universe.

An LC circuit in series(Capacitors and inductors) exhibits “negative resistance” properties

LC circuits, made out of capacitors and inductors, produce their own unique “negative resistance properties” that convert the potential polarity to make a “true potential” conversion where both the electrical field and the magnetic field are converted for the right polarity for the respective battery pole.

Both capacitors and inductors as an LC circuit exhibit “negative resistance” properties which convert the “positive potential” to negative and vice-versa. Capacitors when exposed to positive potential store it as positive potential but will discharge it as negative potential and capacitors thus will convert the positive “electrical field” to negative. Similarly, inductors when exposed to a positive magnetic field will store the potential as positive potential but will discharge it as negative magnetic potential and thus will change the magnetic field to negative.
And similarly, capacitors when exposed to negative potential will convert the negative “electrical field” to positive while inductors when exposed to a negative magnetic field will change the magnetic field to positive.
Thus an LC circuit in series does a “true polarity” conversion by changing both the electric field and the magnetic field to the same but opposite polarity.
Because of this property when an LC circuit in series is used, the potential from the positive pole of an energy source is routed back to the negative pole with both negative electric field and magnetic field polarity, thus this mechanism is used to recondition the returning potential to the source.

Charge Potential of the System

The cold potential method utilizes the capacitor(s) bank to store electrical energy where the overall output of the apparatus Charge potential(E) is a function of the frequency and the amount of electrical energy stored in the capacitors bank on a per cycle basis as a function of frequency to produce a dynamic charge potential(E) which can be converted into electrical potential, where the produced Potential rate (U) per period(T) is defined as

$$U ( Charge potential per period ) = \frac{1}{2} * {CV}^{2} / T where$$

$$T ( period ) = ( \frac{1}{frequency} ) in seconds$$

and where the Charge potential(E) of the circuit is defined as a function of the operating frequency of the circuit as follows:

$$( E ) Charge potential = \frac{1}{2} * {CV}^{2} * freq \qquad ( 206 )$$

thus

$$E 2 = \frac{Freq 2}{Freq 1} * E 1$$

indicating that Charge potential(E) increases as a function of frequency increasing. The charge potential (E) output of a converter circuit is then a direct function of the operating frequency (Hertz) in conjunction with the size of the voltage of the battery as electric energy storage(DC volts) and the size of the operating capacitor in storage capacity (H) .

As an example of the charge potential calculation for a particular application for a cold potential system containing a capacitor storage of 0.25 Farad operating with a battery of 24 volts oscillating at 100 Hertz at 70% efficiency has a charge potential output capacity of :

Cold charge potential=½*(0.25 F)*(24 volts) (24 volts)=72.0 joules(watt-sec)

The capacitor charges and discharges deliver 72 watt-sec charges every 0.01 period of ( 1/100) sec or 72 watt-sec times 100 Hertz

Charge potential=7200 watts=7.2 Kw at 70% efficiency=5.04 Kw=6.75 Hp

Given a dual system made out of two identical circuits for the primary and secondary electromagnetic circuits, as shown in FIG.12, where the circuits operate at 100 and 500 Hertz respectively are then able to produce an excess charge potential rate (E2/E1) :

Where E2=E1* freq2/freq1, or E2=E1*500 Hertz/100 Hertz=5*E1 (five times)
Indicating that the secondary circuit system has five(5) times more charge potential (E2) than the primary circuit(E1).

For the cold method the resonance frequency and the proper design for a particular resonant frequency is not as critical as the need to size the capacitor to be large enough to store as much energy as possible. Thus capacitor must be properly sized for voltage and for maximum desired charge capacity and storage.

### BRIEF DESCRIPTION OF THE DRAWINGS

The drawings illustrate preferred embodiments of the methods and devices of the discovery and the reference numbers in the drawings are used consistently throughout. New reference numbers in FIG. 1 are given the 100 series numbers,

FIG. 2 are given the 200 series numbers and so on. Similarly, new reference numbers in each succeeding drawing are given a corresponding series number beginning with the figure number, as follows:

FIG. 1A depicts the basic 150 EM Link cornerstone concept of the patent as the electromagnetic energy waves generator which can produce electromagnetic energy waves which recuperates the electrical energy.

FIG. 1B represents a general frequency profile input signal required to drive the oscillation of the EM Link

FIG. C represents Maxwell's Fourth equation which states the existence of the Displacement current which is mutually exclusive with Ohm's current.

FIG. 1D is a depiction of the step to step process of the cold potential method to utilize the electromagnetic energy wave to generate additional potential to sustain itself.

FIG. 1E is the depiction of how an electrical transformer becomes a two channel output of inductive magnetic energy when receiving an AC potential input in the form of cold Displacement current.

FIG. 1F is the depiction of Closed loop Negentropy flow with dual electromagnetic energy wave generator unit,

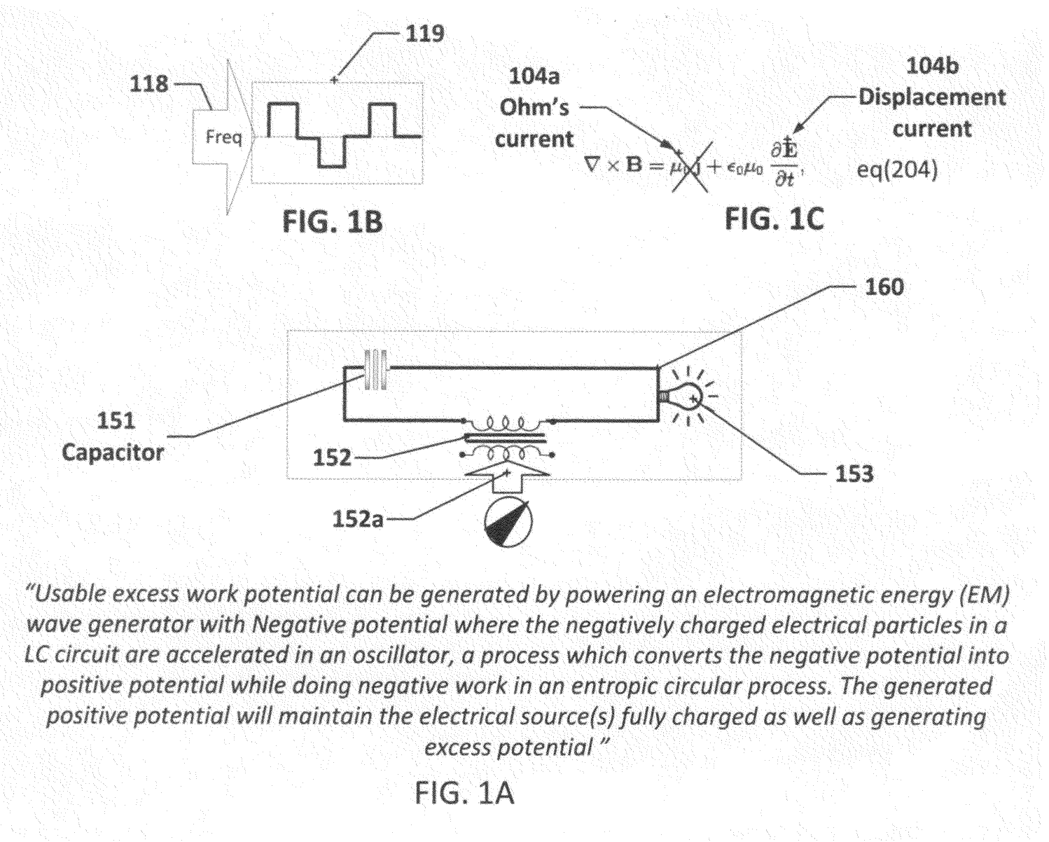

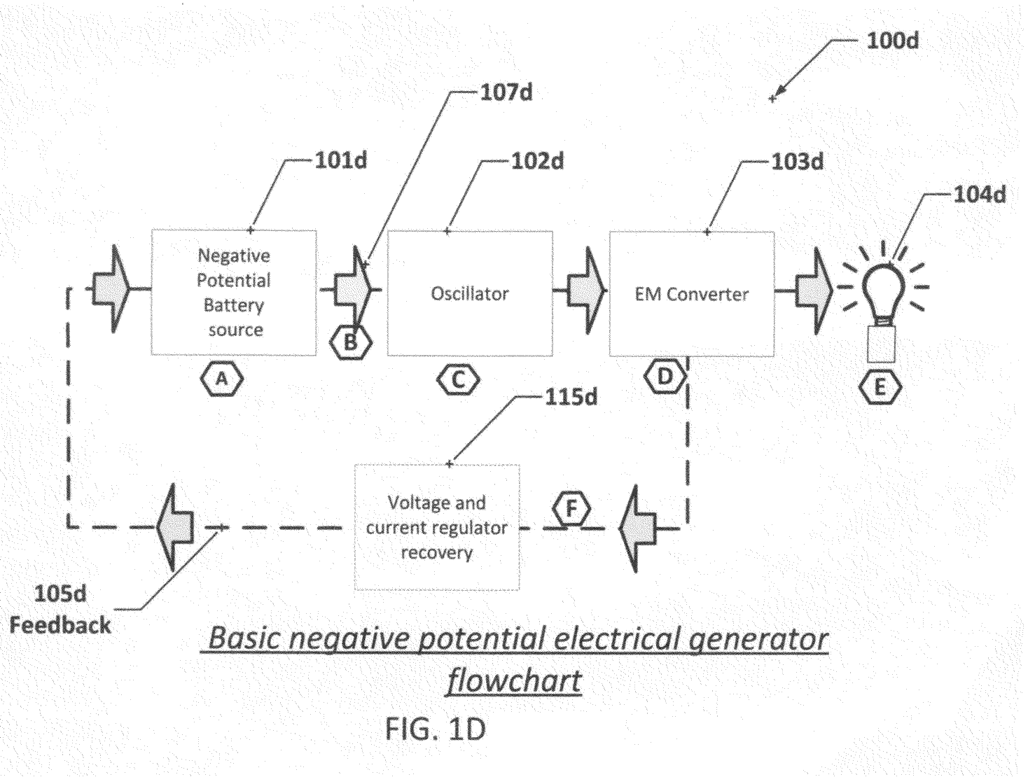

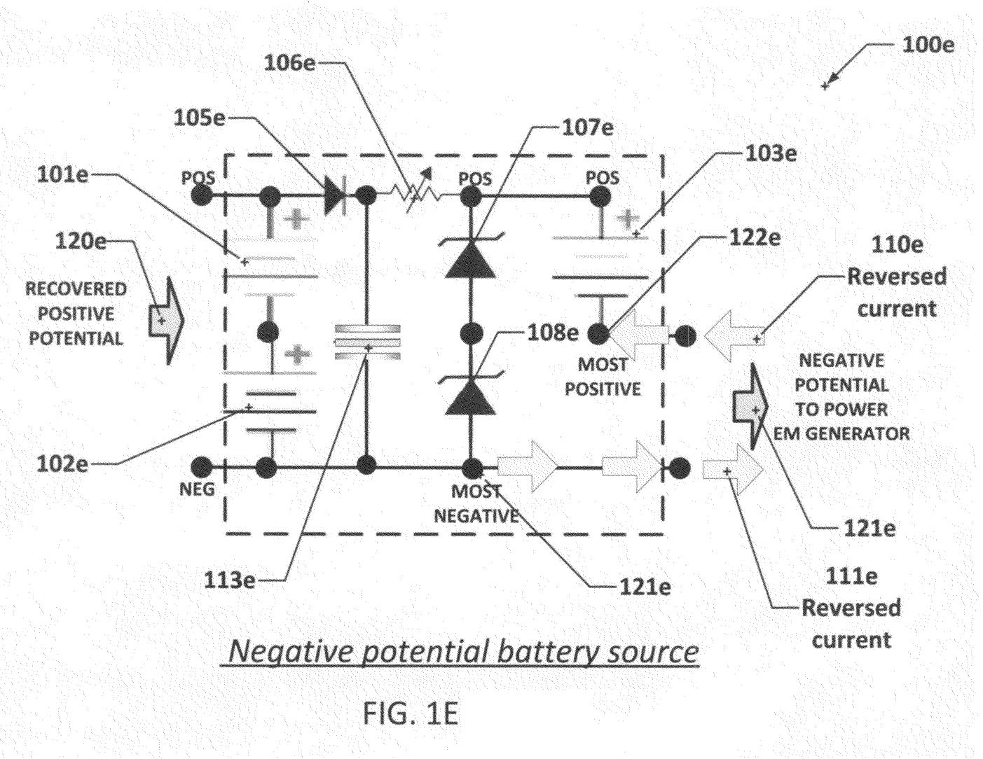

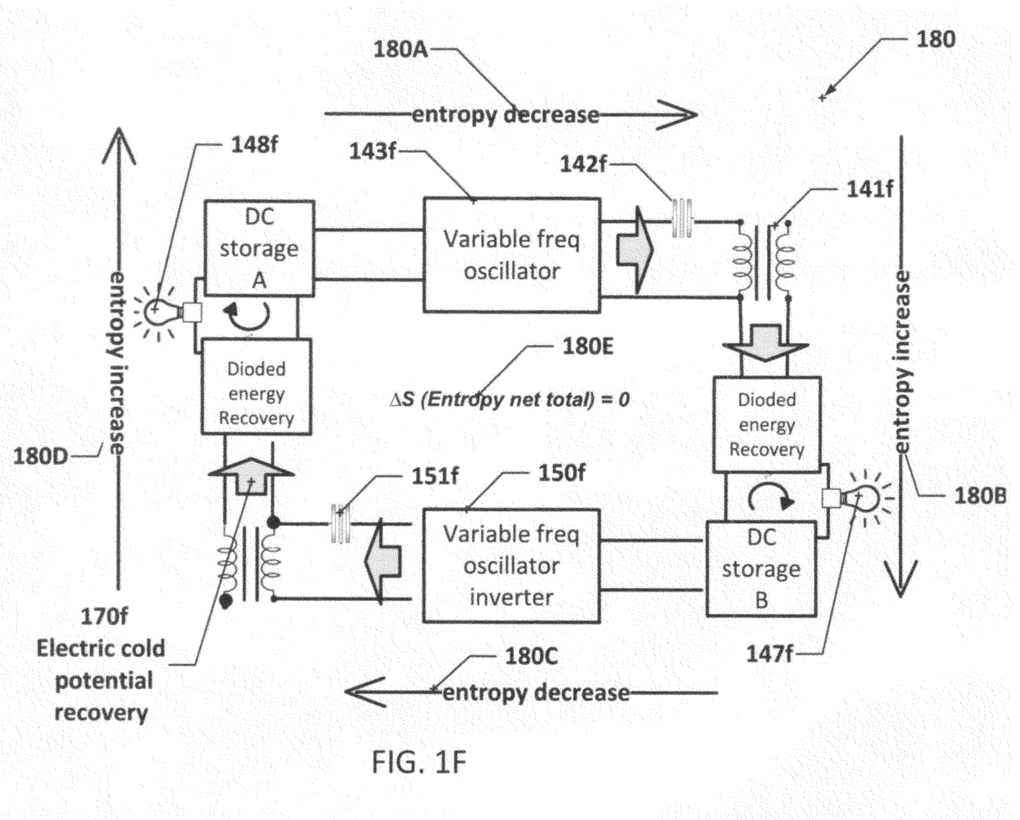

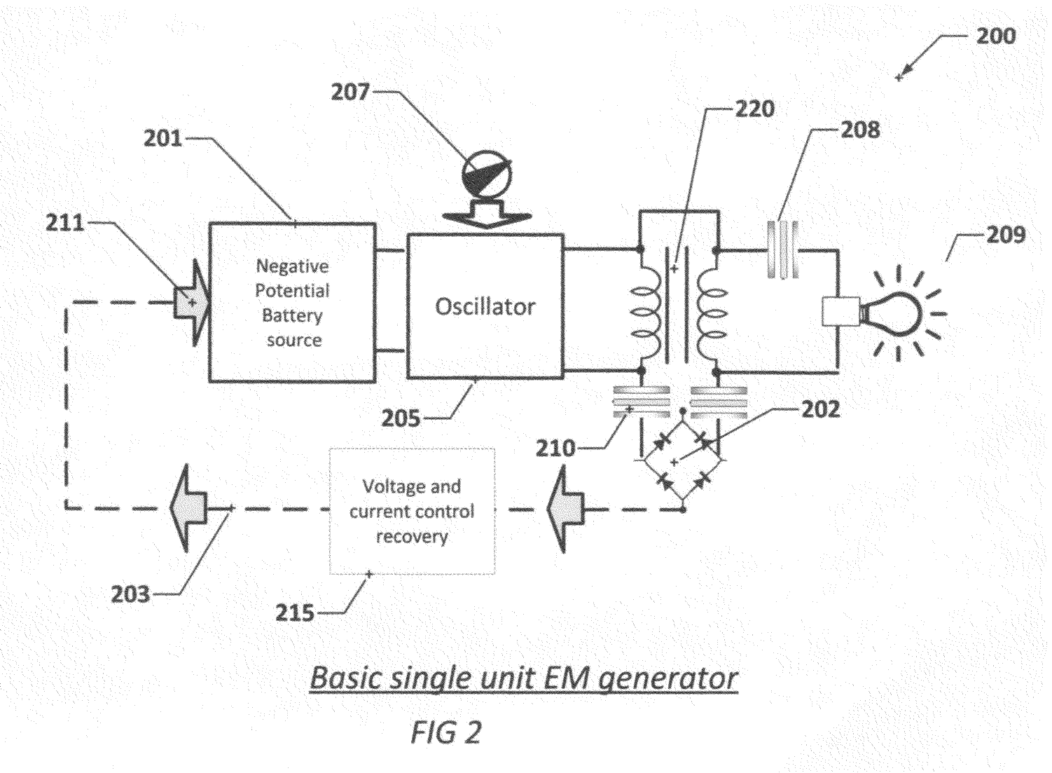

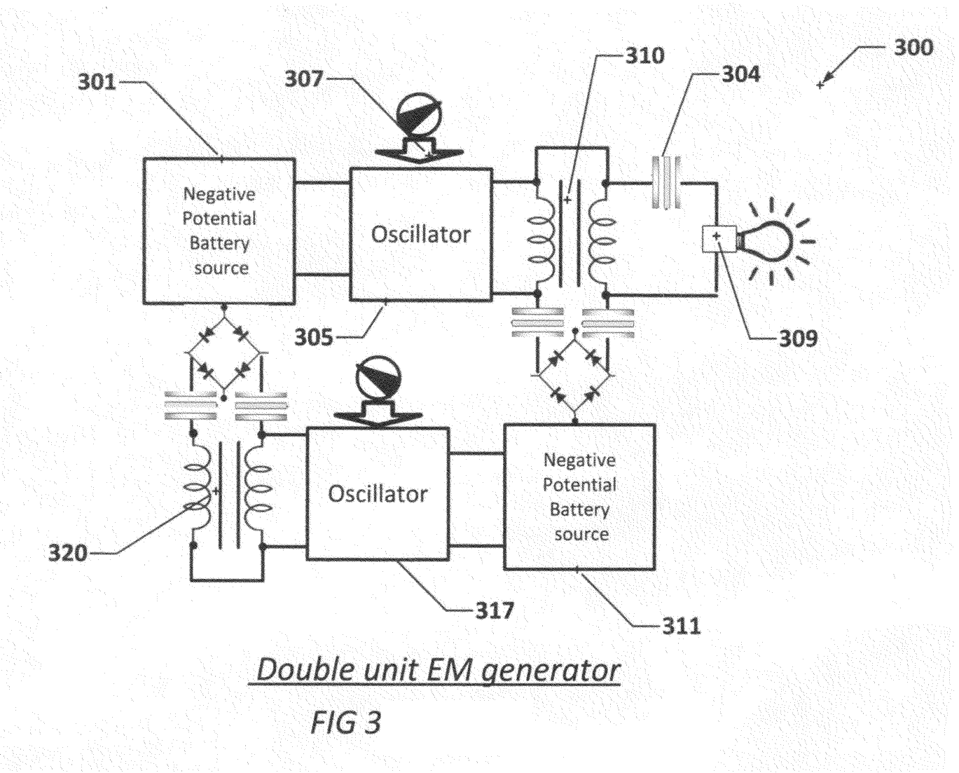

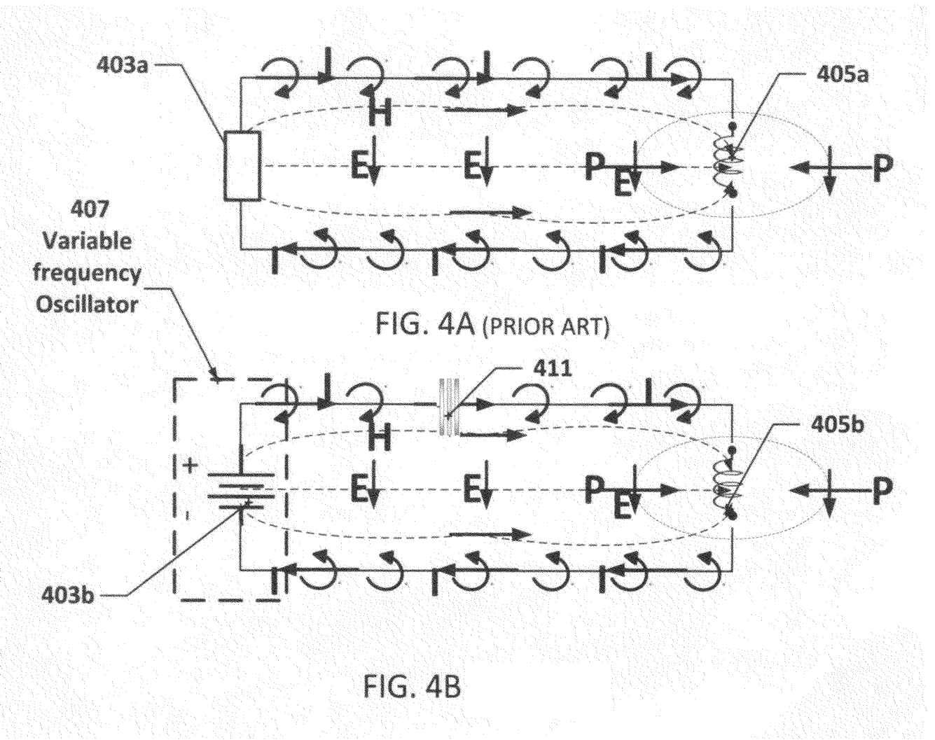

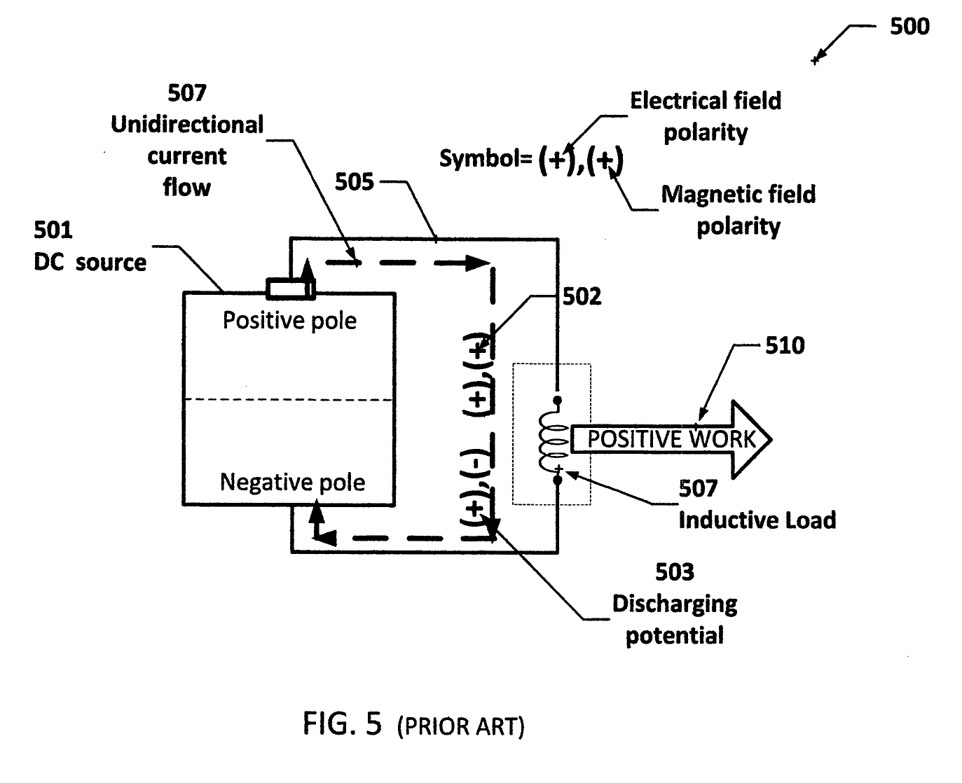

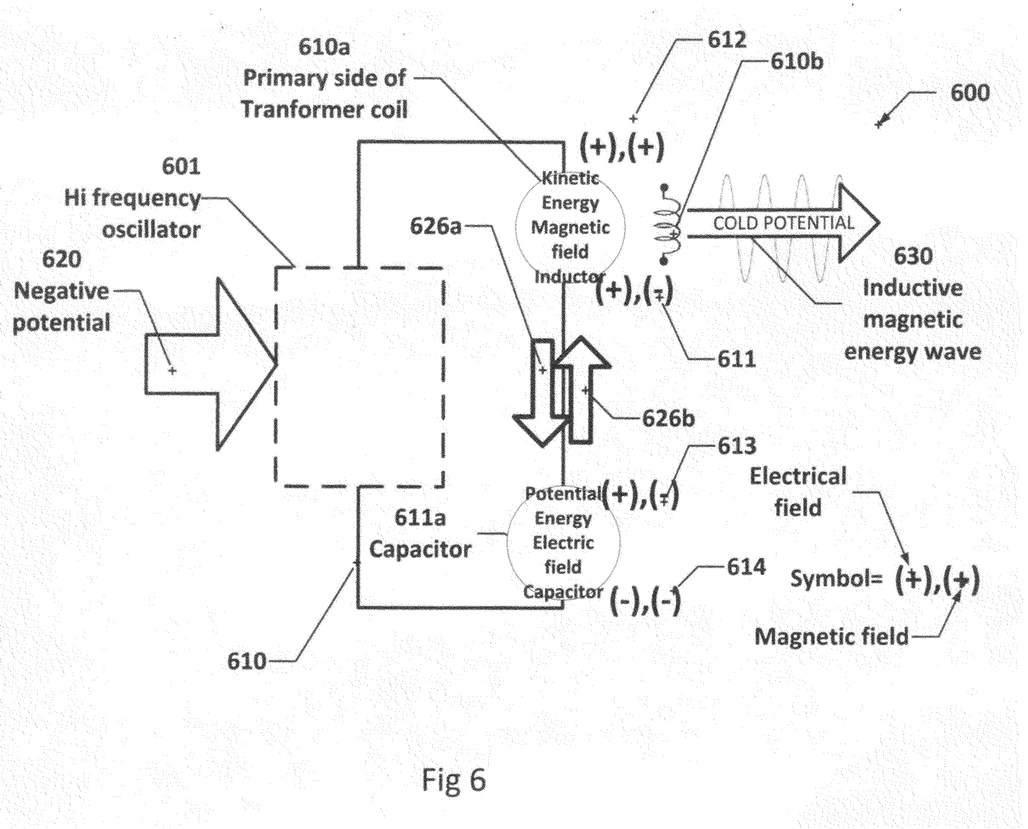

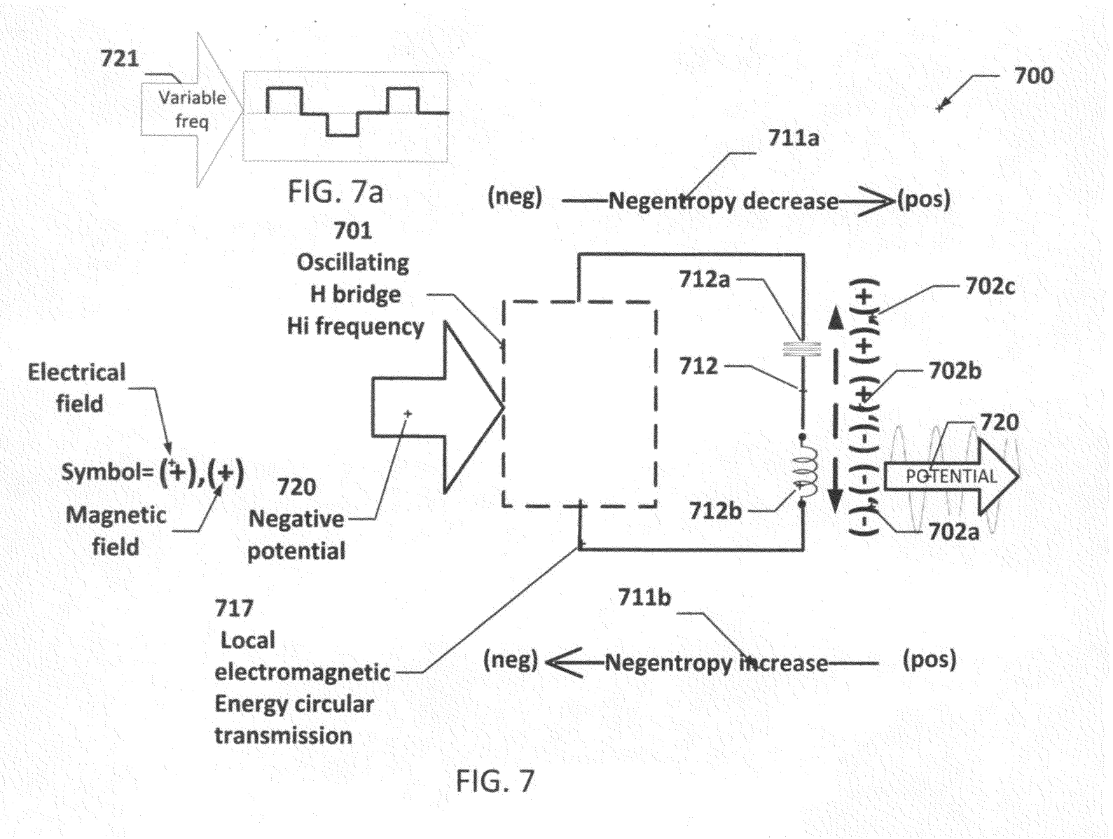

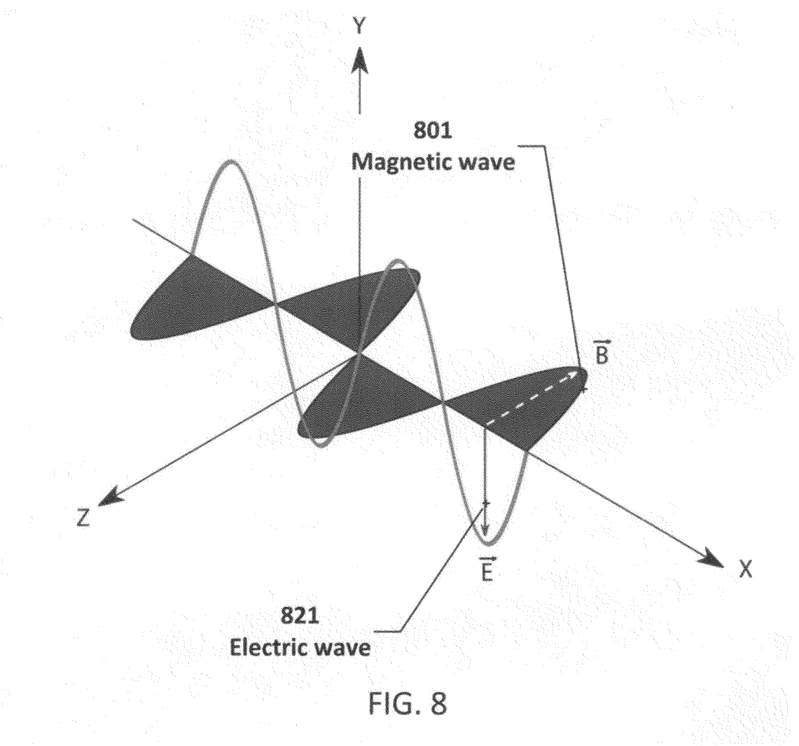

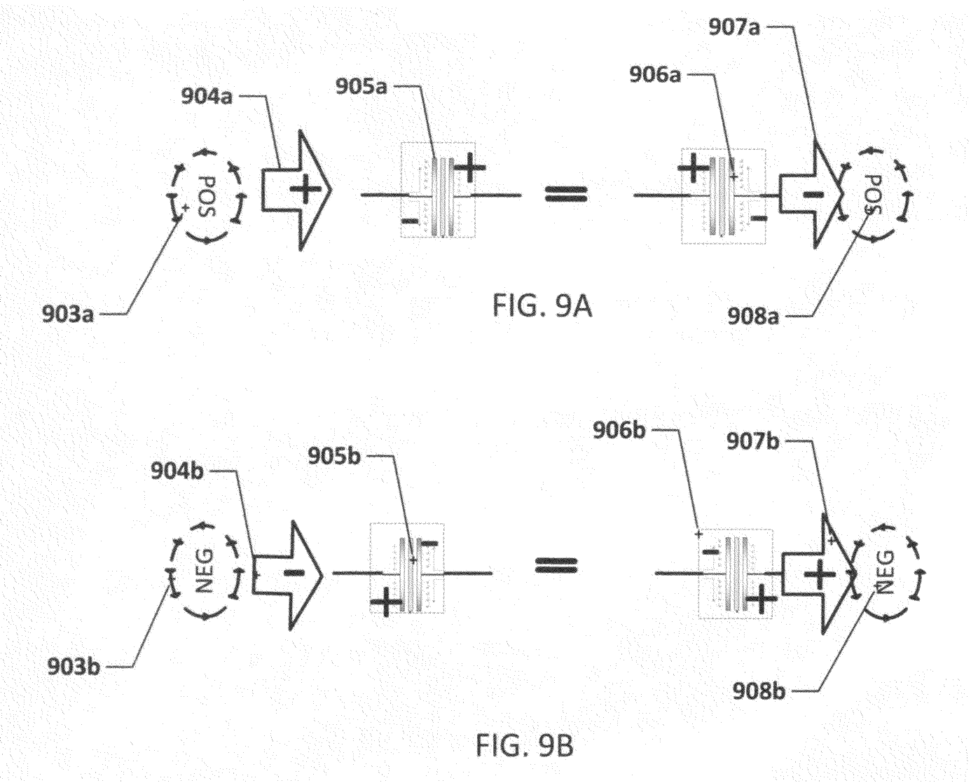

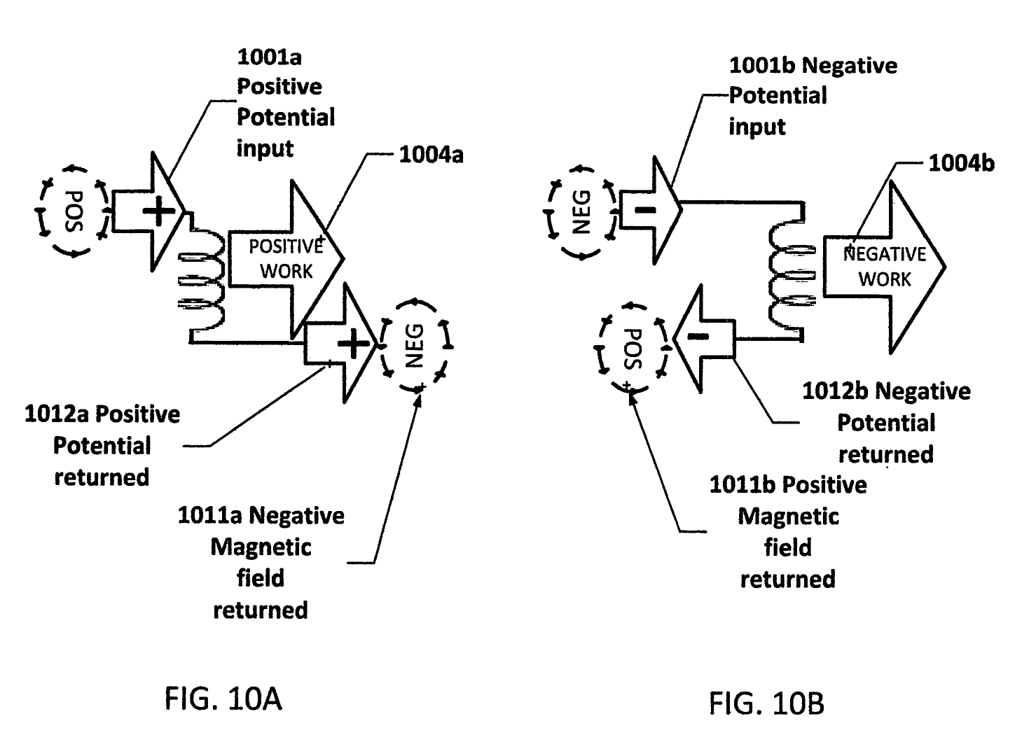

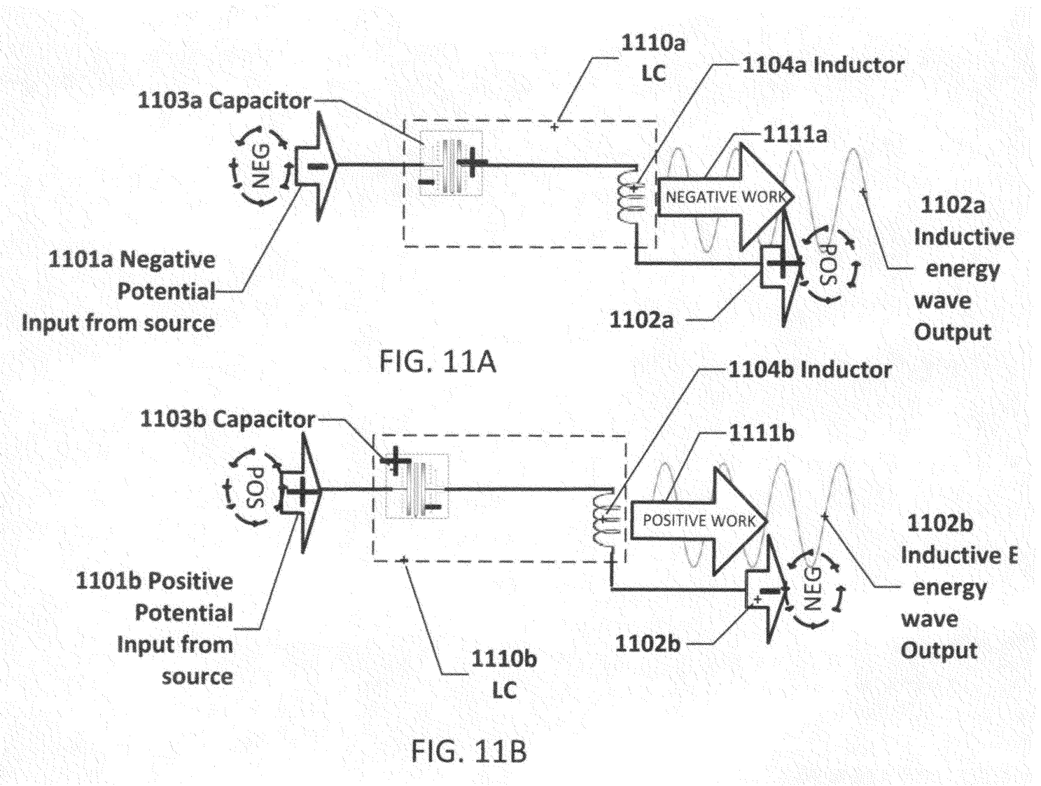

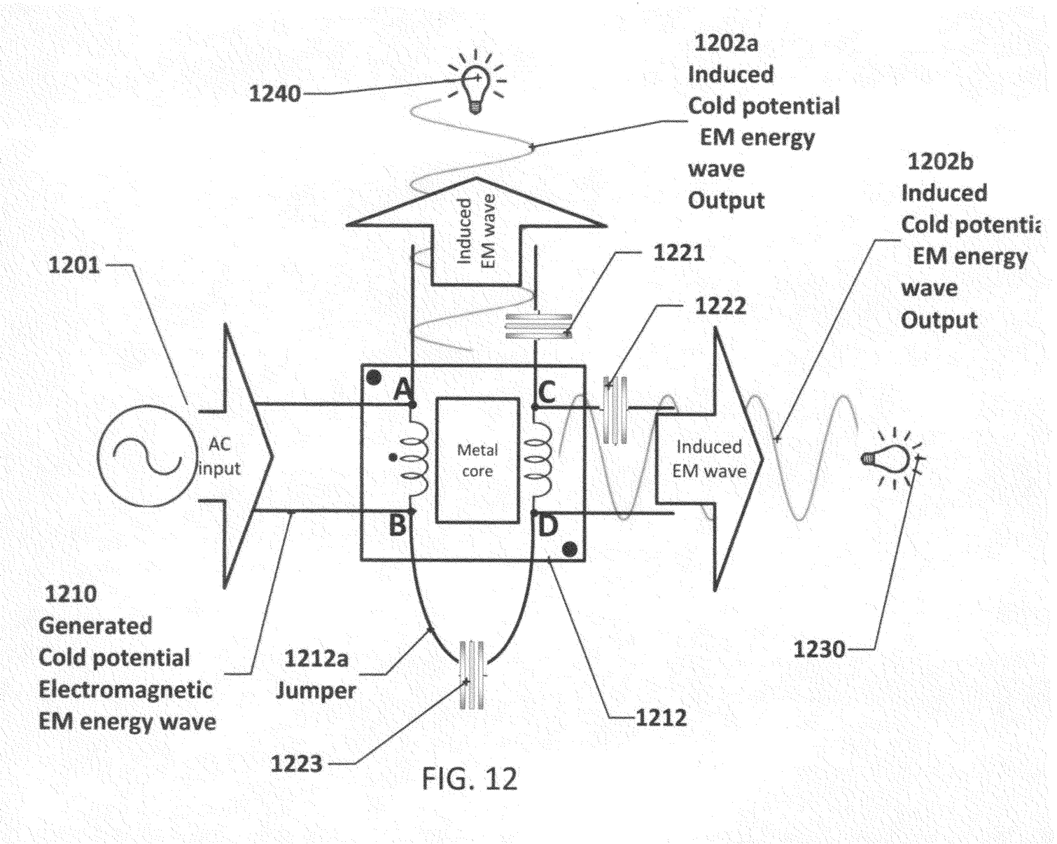

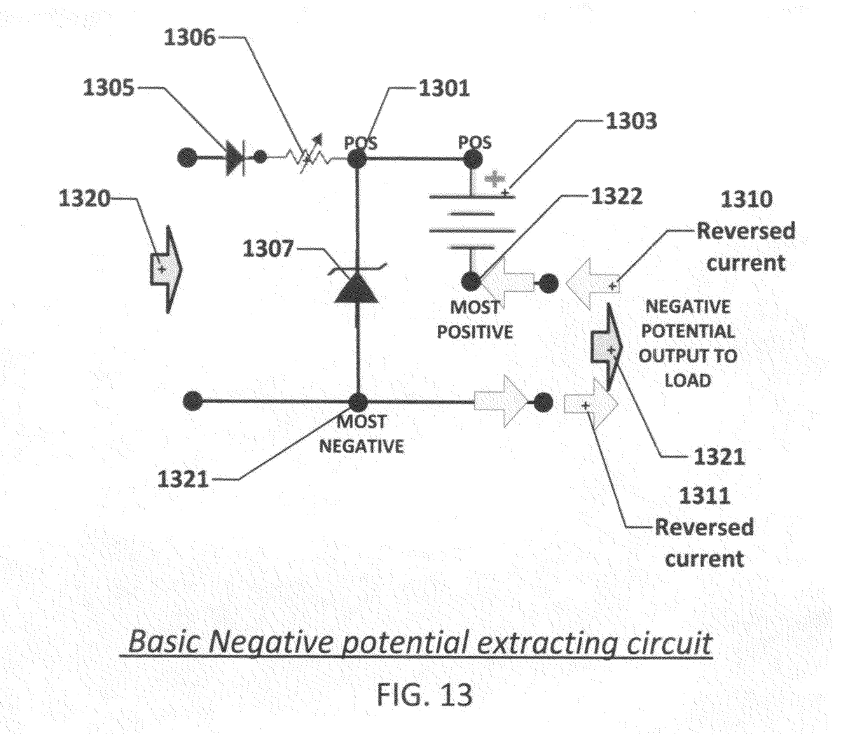

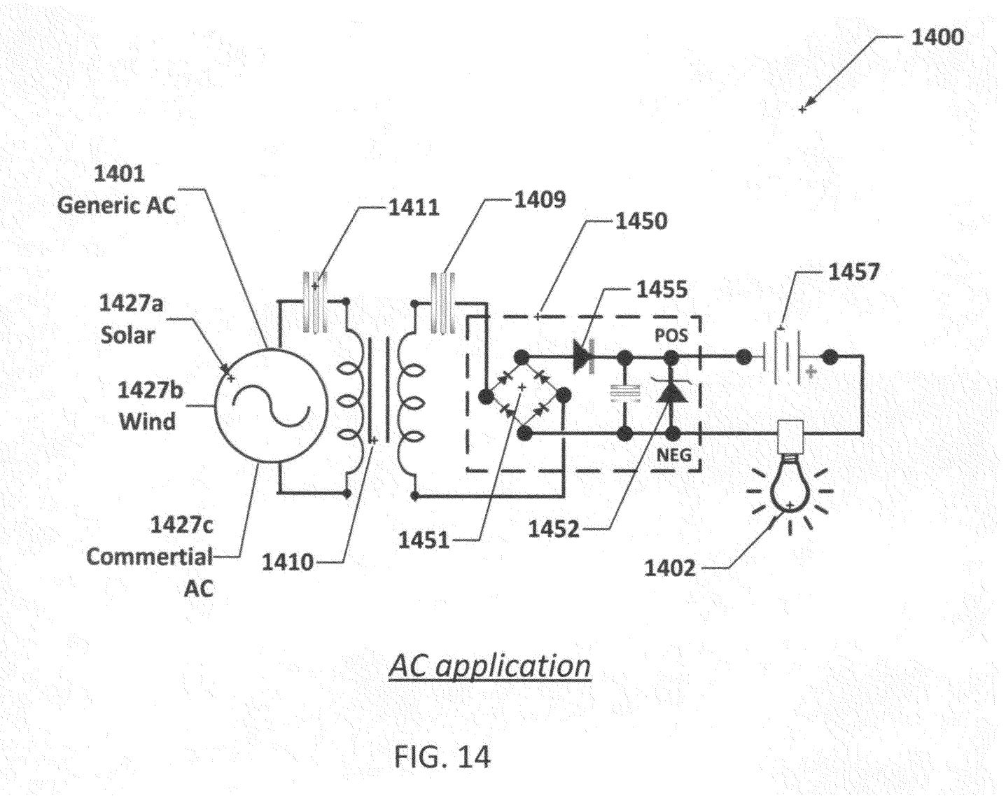

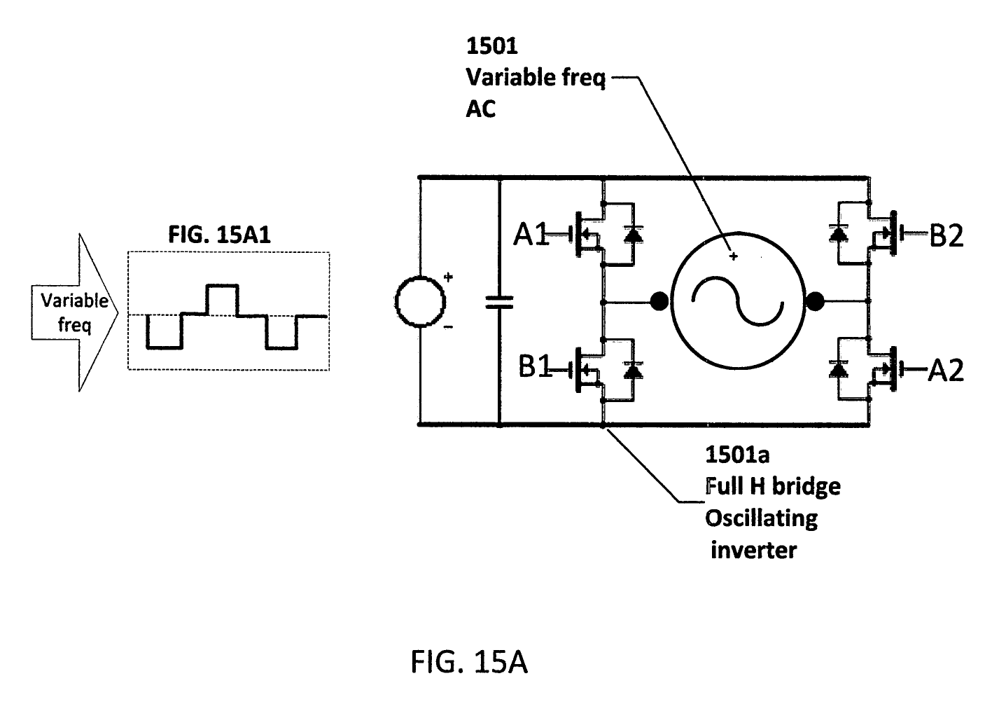

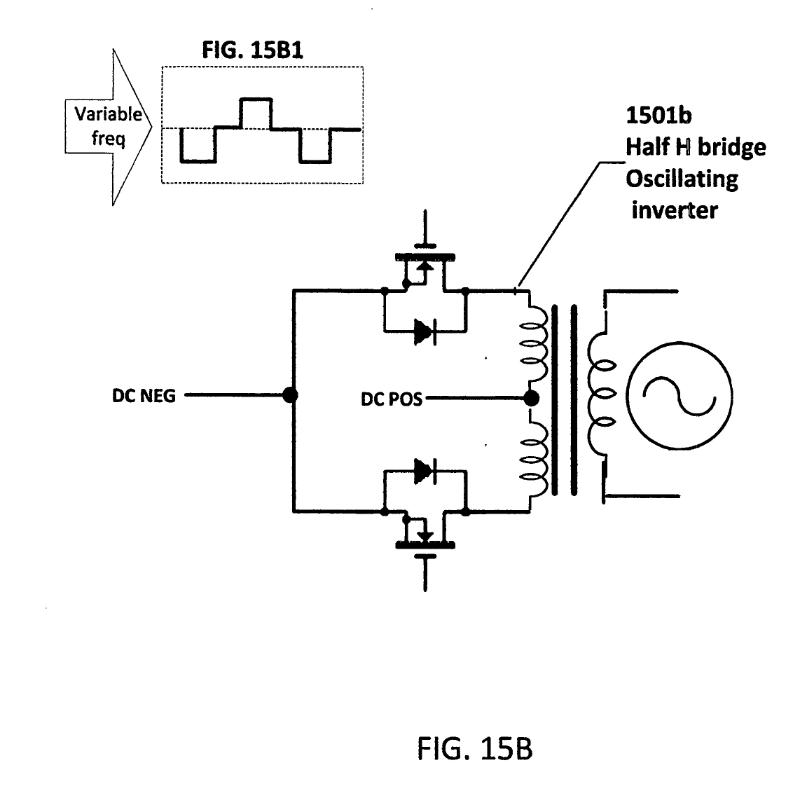

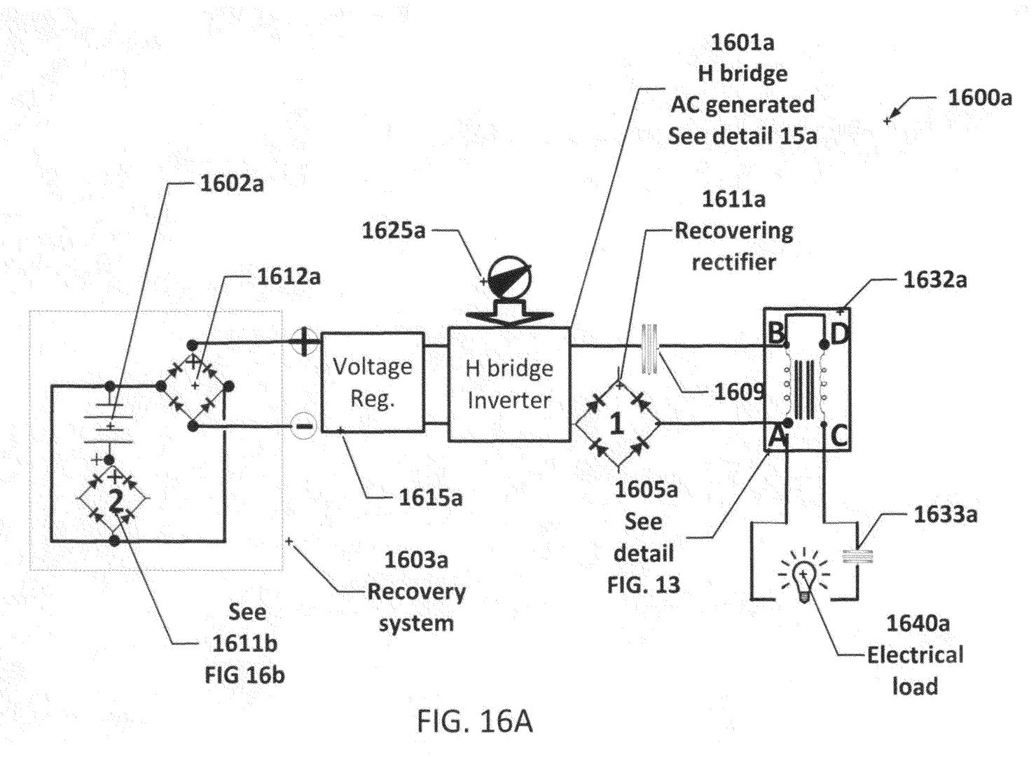

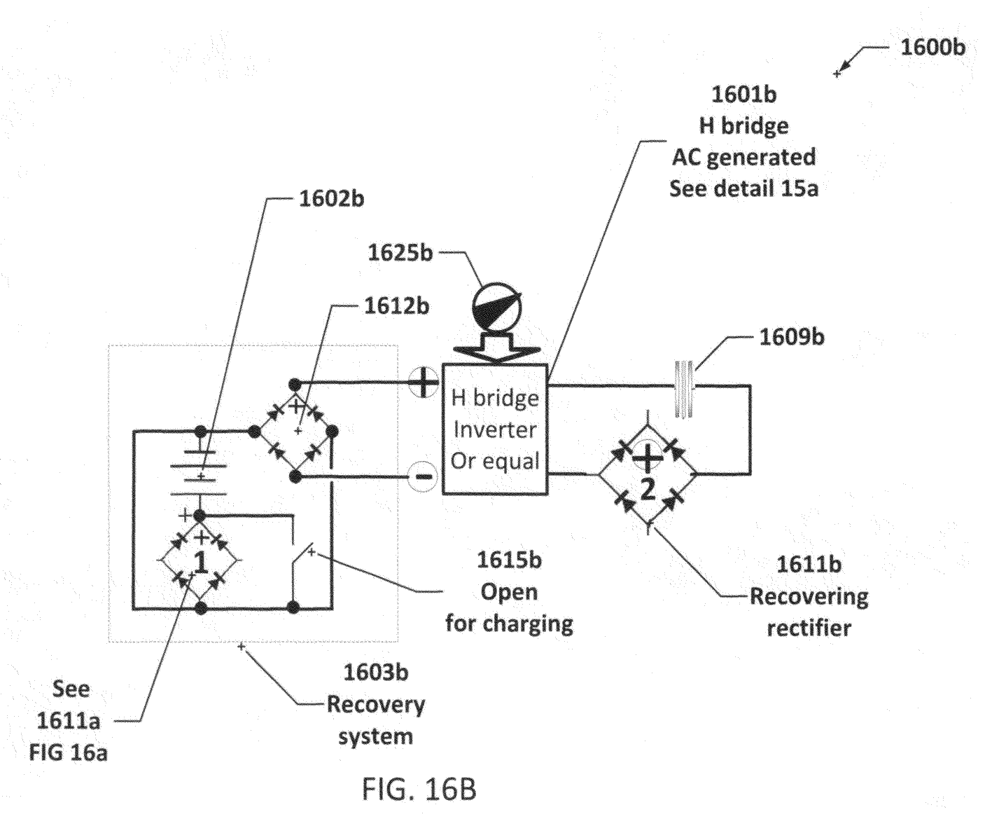

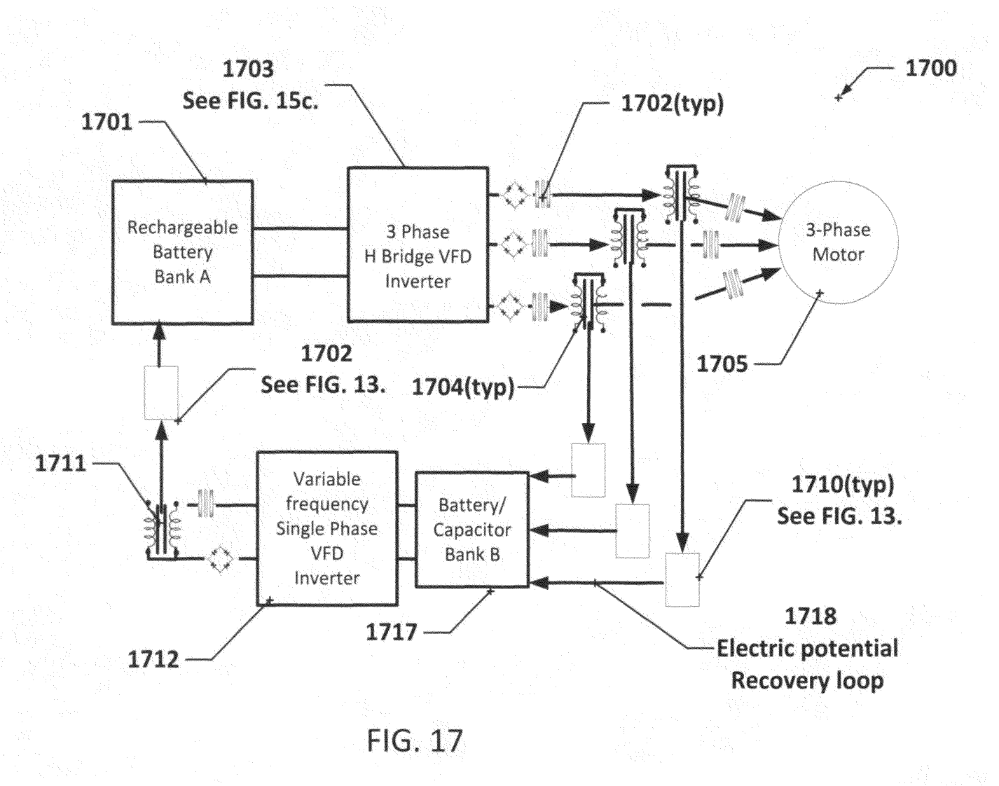

FIG. 2 shows the Main embodiment of a full cold potential method self-sustaining generator device which uses dual electromagnetic wave converter back to back to form a circular potential system.

FIG. 3 shows the Second embodiment of a full cold potential method self-sustaining generator device which uses two electromagnetic wave convertor back to back to form a circular potential system which uses one energy source.

FIG. 4A (PRIOR ART) and FIG. 4B(NEW ART) are a depiction of the Classical Poynting vector theory for the transmission of energy using electromagnetic wave energy methods versus the (New art) variation of the Poynting vector theory using a capacitor and inductor(LC) in series with an oscillating electrical source as used by the Cold potential method.

FIG. 5 (PRIOR ART) is depiction of present wasteful utilization practices of electrical energy circuit application which produces hot current destroying the electrical dipole and discharging the source.

FIG. 6 (NEW ART) is a depiction of the basic electromagnetic energy wave generator cycle using an 601 oscillating source and a primary LC circuit which produces an 630 inductive magnetic energy wave via the 610b secondary coil of the electrical transformer.

FIG. 7 (NEW ART) is a depiction of the circuit which converts electrical energy into magnetic energy which by default reconditions the potential of the circuit making it a net zero change entropy change process.

FIG. 7A (NEW ART) is a depiction of the frequency profile required.

FIG. 8A and FIG. 8B are a depiction of the inductors reversing of the magnetic field polarity before and after doing work.

FIG. 9A and FIG. 9B depict the behavior of a capacitor when exposed to a positive and negative potential pulse respectively.

FIG. 10A and 10B depict the behavior of an inductor when exposed to a positive and negative potential pulse respectively.

FIG. 11A (NEW ART) and 11B (NEW ART) depict the behavior of an LC circuit when exposed to a potential pulse which reconditions the potential after use by simultaneously changing both the electrical and magnetic field to an opposite polarity thus reconditioning the potential for storage and re-use.

FIG. 12 (NEW ART) shows a depiction of the electrical transformer for practicing the cold potential art as the point of convergence for the conversion of electromagnetic energy waves into magnetic energy waves as well as radiating source of cold electromagnetic energy in the form of waves thru two channels .

FIG. 13 (NEW ART) shows a depiction of the electrical circuit to recover electromagnetic energy waves to electrical energy for practicing the cold potential method using capacitors and diode means for rectification of the potential. FIG. 14 (NEW ART) shows a depiction of an utilization of AC to produce cold potential electromagnetic energy converter without potential burden to the source.

FIG. 15A and 15B show a depiction of the preferred H bridge oscillator and the three(3) phase H bridge oscillator respectively as a method to convert DC to AC.

FIG. 15A1 (NEW ART) is a depiction of the frequency profile required.

FIG. 16A, 16B and 16C are generic typical variations of applications to practice the new art using an existent generated AC energy source.

FIG. 17 (NEW ART) depicts the utilization of the presented cold methods for a three(3) phase motor application.

### DESCRIPTION OF THE PREFERRED EMBODIMENTS

FIG. 5 (PRIOR ART) shows the present utilization method which consumes the electrical potential.

Present electrical energy utilization methods consume the electrical potential primarily because our present electrical sourcing methods shortens the source and secondly because our present utilization methods generate dissimilar polarity potential when using the potential and after returning the electrical potential to the source after its use.

Dissimilar polarity returned to the source (like item example 503 contains dissimilar polarity as a positive electric field(+) with a negative magnetic field(−)) which discharges and destroys the electro-chemical dipole process of the source.

The Cold method, as a new art, of this patent negates this from happening. This patent will demonstrate that the electrical dipole (whether DC or AC) does not have to be destroyed and yet it can be fully conditioned for reuse.

If properly practiced, it is possible to extract usable energy potential from the electrical dipole without consumption and without violating any of the Laws of Thermodynamics. This is the main theme of this patent

The fact is that batteries (including AC energy sources) are presently being used in a “short circuited mode” and producing miss-matching potential polarity potential which is returned to the source continually in a manner which destroys the stored electrical dipole.

Our general miss-assumption today is that electrical energy is a complete energy entity, which in fact , it is not. The more complete energy entity is electromagnetic energy waves which includes both an electrical and a magnetic field flux working together in the form of a wave. The actual mechanics of “our electrical potential consumption” today is that we are attempting to run electrical systems by using just one component of the energy elements available to us. We are consuming the electrical field instead of consuming magnetic field which produces the emf forces. Our society is burning away the electrical potential and not using the magnetic potential of the electrical energy entity which is the entity that does work for us.

If we wish to save our electrical fuel resources such a oils and fuels for electrical generation in the future, then we must reclaim energy after its use, then our electrical devices need to run on electromagnetic energy waves as a complete renewable energy form that is electrical energy and magnetic energy flux fields working together in the form of a wave.

Whenever electromagnetic energy waves are created both an electrical field and a magnetic field come into existence. The magnetic field can always do the work and the electrical field can be recovered for re-use. This is the main impetus and requested rights of this patent application. This demonstrates that the proper way of using electrical potential is to use electrical potential to generate magnetic potential which does the work without “hot currents” which consumes the potential.

Our utilization systems today “electrically shorts the battery” to obtain the potential from the source thus creating hot current and returning “dissimilar potentials” to the source. Our present electrical systems create inefficiency in the form of hot current or heat as per Ohm's law. We must think of “current heat” as an alarm of our miss-use of electrical systems indicating gross miss-use and not as the barometer of the amount of power available.

As shown in FIG. 5, (PRIOR ART), the 500 Present consumption method uses the 501 DC Battery and 507 Inductive Load which returns dissimilar potential shown as 503 Returning potential which contains (+),(−) potential indicating that it returns dissimilar potential to the negative pole containing positive electric field with a negative magnetic field. In this example, the positive electric field returned to the negative pole of the 501 battery will discharge the energy source by destroying the stored electrical dipole.

FIGS. 1A, 1B and 1C (NEW ART) depict the fundamental concepts of the new Cold potential concept.

FIG. 1A shows most basic and simplest Electromagnetic energy wave converter unit shown as the most basic 150 EM link unit which is most compact circuit used to convert electrical energy to electromagnetic energy waves which exports electromagnetic energy waves in the form of inductive magnetic waves to export energy in the form of a wave.

The 150 basic EM link represents the smallest most basic electromagnetic energy wave generator unit which carry the attributes of the new art. As used in this patent, it generates electromagnetic energy (EM) waves which are produced by the acceleration of electrical charges in an AC oscillating environment of varying frequency in series with an LC circuit (capacitor and inductor) evoking a cold Displacement current wave and disabling the hot Ohm's current production while still maintain an energy transmission process.

The 150 basic EM link receives AC electrical potential from an outside energy source, it internally generates a cold potential electromagnetic energy wave (EM), exports an inductive magnetic wave via the inductor, reconditions and recovers the electrical potential back to the energy source thus becoming a totally self-sufficient device which generates a continuous radiating of magnetic energy to other parallel inductors.

FIG. 1A shows the 150 EM link as the most basic electromagnetic energy wave generator producing circuit which acts a broadcaster of electromagnetic energy wave to the secondary coil of the 153 transformer. The 150 basic EM link comprises the 152 Oscillating electrical source which oscillates the electrical charges at a variable frequency 152a, in series with the 151 capacitor and the 153 Transformer which acts as an Inductive load. The potential of the system is oscillated back and forth as shown as 155 Oscillation which occurs at high frequency with a 155 net zero entropy change process shown as a cyclic process where a Negentropy(negative entropy) decrease followed by a Negentropy increase which yields a net zero entropy change.

The unitary 150 EM link is an electromagnetic energy wave as the representative of the reversible cold process circuit which is able to produce alternatively both “negative work” and “positive work” thru its 153 Transformer inductor member thus carrying within both the capacity of producing usable potential as a net zero energy change work process while qualifying as a reversible process which carries the entropic feature of being net zero entropy change process without violating the laws of Thermodynamics.

The 150 EM link is able to transmit usable work thru the alternate production of “negative work” and “positive work” alternatively thru the 153 inductor element thus producing the net zero energy change work process which does not discharge the energy source.

The 150 EM link is able to show how the electrical potential is recovered as it will be shown in FIGS. 8a and 8b, FIGS. 9a and 9b, FIGS. 10a and 10b and FIG. 1 la and 11b,

FIG. 1B is a graphical representation of the high frequency signal required to drive the oscillator (frequency range can varied as per application).

FIG. 1C is a graphical representation of Maxwell's Fourth equation which deals with the “currents profile signature” developed by the electromagnetic circuit which in the cold method uses a circuit which contains at least one capacitor in series or an LC circuit.

As shown in equation (204), the first term represents the Ohmnic hot current developed, that we use today, as a function of the resistance of a hard connectivity conductors and the second term of the equation represents the Displacement current which relates to the “cold current waves” developed by capacitors in an AC circuit which enables the energy transmission thru the use of electromagnetic energy waves and the ether thus enabling the Cold potential methods of this patent.

FIG. 1D (NEW ART) is a graphical representation of the closed loop entropy flow process of the 100d basic electromagnetic energy wave converter unit which is made out of 150 EM links as shown on previous FIG. 1A with an energy recovery circuit as shown on FIG. 13.

The 155a Negative entropy (negentropy) decreases from step A thru C and 155b increases from step C to E thus becoming a net zero entropy process.

The process is made out of seven (7) steps which describes its operation as shown on FIG. 1D as follows:

[symbol] Static DC is supplied to oscillator inverter device such as H Bridge inverter

[symbol] DC is converted to variable frequency AC

[symbol] No AMP DRAW cold potential electromagnetic energy(EM) waves are generated

[symbol] Electrical potential portion of the EM wave is returned to source

[symbol] A new complete cold potential electromagnetic energy wave is re-generated.

[symbol] Electrical and Magnetic energy waves are converted back to useful energy to charge the battery and motivate loads.

[symbol] Load is driven by positive differential potential while charging battery

It is important to highlight that step (C) and (E) are the key concepts of the Cold potential process of this patent.

Step (C) represents a no “amperage draw” to obtain potential without “electrically shortening” the source, a method which is representative of the cold Displacement current as predicted by Maxwell. This shows clearly that it is possible to use the potential of an electrical source to generate work without having to consume the potential.

Equally important is step D which indicates that if energy is passed to the secondary coil of a transformer in the form of a cold potential magnetic energy wave, as per Lenz's Law. The magnetic energy wave is then automatically paired with an equal electrical energy wave; this is the basics for magnetic inductance or “mutual inductance” to generate additional electrical potential. Thus the transformer in this case becomes an “electrical generator”.

FIG. 1E (NEW ART) is a graphical circuit representation a 150 EM link of electromagnetic energy wave branching.

The 100e basic electromagnetic converter unit comprises of a 101e Rechargeable energy source or reservoir, a 102e high frequency oscillator inverter which accelerates the electrical charges, 111e capacitor, 120e Transformer unit, 112e capacitor, 135e Transfer plug in series with load 130e and the 125e Transfer plug in series with load 140e.

The 150a Electromagnetic energy wave is produced by the incoming oscillating energy as it goes thru 113 capacitor and the primary coil of 120e Transformer which produces two lateral EM branches, 150b and 150c, as the electromagnetic output. The energy output of the 150b and 150c EM branches is recovered by 125a and 135a EM diode plugs as shown in FIG. 13. The significance of the output 150b and 150b is that this output represents an induced cold Displacement current EM energy wave output which gets completed as a complete reformatted electromagnetic energy wave thus becoming generated electrical potential.

FIG. 1F (NEW ART) is a depiction of the Entropy flow of a 180 dual EM Converter unit which exhibits a closed loop net zero entropy change as depicted by 180E ΔS (Entropy net total)=0 by adding 180A (negentropy decrease) plus 181B (negentropy increase) plus 180C (negentropy decrease) plus 180D (negentropy increase) which yields the 180E zero net entropy change.

FIG. 2(NEW ART) is the main embodiment of the 200 Circular self-sustaining dual unit Cold potential electromagnetic generator which has two batteries and two loads. The 200 Unit is made out of the 204 Primary unit and 205 Secondary unit. As an operational example, 204 Unit may operate at a frequency (such as 60 Hertz) while 205 Unit may operate at a variable high frequency (such as 1000 Hertz) thus operating at a higher frequency thus generating a higher charge capacity with equal higher electrical potential.

FIG. 3 (NEW ART) is a second embodiment of the 300 Circular self-sustaining Cold potential electromagnetic generator dual unit that uses one 301 battery bank and uses only one 301 source.

FIG. 3 depicts the 300 dual Cold potential electro-magnetic generator as correspondingly label to have a dual electromagnetic energy wave generator unit by being connected to the two back to back Cold potential electrical to electromagnetic energy converters shown as 304 and 324.

The 304 and the 324 Electromagnetic convertor can operate at a different frequencies as such that the 304 Electromagnetic convertor may operate at independently different frequency to maintain the load potential needs while the 324 Electromagnetic convertor operates at another frequency to maintain the potential needs of 301 Battery source needs.

Because the 310 and 327 Transformers are exposed to 350a, 350b Electromagnetic energy waves input they become electrical potential generators thru their own induction, they maintain 301 and 326 Energy sources charged respectively. The potential generated by the transformers is passed to the energy sources by a capacitor-diode plug (see FIG. 13) or an equivalent similar rectifier which does not create harmonics. A half wave capacitor-diode plug as shown in FIG. 13 is preferred to eliminate the possibility of Third harmonics generated if a full wave rectifier is used which will affect the energy transmission.

The overall electrical output occurs as 330 Load which may preferably be an inductive load or which can use a rectifier to convert for a DC potential application.

FIG. 4A (Prior Art) and 4B (NEW ART) show the electromagnetic wave energy transmission method used by the Cold potential method. Under the predicates of the classical Poynting vector theory where “energy can be transferred” without any hard metallic connectivity, this is shown in FIG. 4A in its raw classical form.

As shown in FIG. 4A (Prior Art), the predicted classical Poynting vector theory relates to an energy transmission method which implies the use of waves of energy in the form of “bursts or pulses” of electromagnetic energy waves for energy transmission and it uses “conduction current” while it does not specifically dictate the “oscillation of the polarity source as a high frequency AC wave”. The Poynting vector as depicted in its classical theory includes metallic conductors which immediately implies hot current because of the resistance of the wire, the cold potential method in this patent revises its application to have “an LC circuit” like in a inductor and capacitor in series which creates an electromagnetic wave at high frequency thus creating a free oscillating energy transmission system as a function of an oscillating “energy source” without metallic resistance which binds the energy exchange thru the resistance of the wire.

As shown on FIG. 4B, the cold potential method, as a new art, refers to the creation of electromagnetic energy waves produced by “reversing of polarity” thus creating waves at a high frequency as defined by the oscillation of the source. Electrical energy is converted to an electromagnetic energy wave as a function of the frequency of oscillation and the “hot current” developed is, by default, replaced by the “Displacement cold current” produced by at least one capacitor in series which produces an alternating “free” electrical field which in turn promotes a “free” magnetic field thus creating balanced electromagnetic energy waves as predicted by Maxwell's Fourth equation (204).

As shown on FIG. 6(NEW ART), the high frequency circulation of electrical potential produced by the 608 Oscillating source in series with 611 a Capacitor and the 610a Primary side of the transformer coil will induce a magnetic field oscillation which will concurrently induce a “time-varying rate of change current” as 625 and 626 Displacement cold currents which invokes mutual inductive work on the 610b secondary coil shown as 630 inductive work which represents an inductive magnetic energy wave.

In electromagnetic terms, the 630 Inductive work is produced as a function of Faraday and Lenz's theory and the frequency of oscillation of the source which becomes the “net zero time varying current” as the Displacement cold current and loads the circuit with an equivalent potential to do work proportional to the amount of kinetic energy stored in the 611a capacitor.

FIG. 7(NEW ART) shows the mechanisms used for the formation of the electro-magnetic energy wave which by default restores the potential for re-use by the de-facto reconditioning of the circuit potential being returned to the source.

As part of the domain of this patent, it is shown that intrinsically the definition of electromagnetic energy wave is made out of an electrical and magnetic field vector wave which must include the requirement of making matching an equal polarity of the electrical and magnetic fields. Thus while electromagnetic energy waves are produced by an oscillating source in series with a LC circuit(as Inductors working with capacitors in series), such electrical arrangement have the unique property of being able of reconditioning the potential for re-use for repowering the circuit by the aligning of the energy potential having the same matching polarity.

When an LC circuit, comprised of an inductor and capacitor in series, is exposed to “a burst of varying polarity” of electrical energy, the inductor reverses the polarity of the magnetic field while simultaneously the capacitor switches the polarity of the electric field thus forming and defining electromagnetic energy wave having same polarity.

By default, an electro-magnetic energy wave is defined as an energy wave having the same electrical and magnetic field polarity. This is hereby presented as new knowledge and as a new process and method to use to recondition electrical potential sources. Electromagnetic energy waves and its matching polarity is the key element for the reconditioning of the electrical potential without consumption.

As shown on FIG. 7, shows a basic method to convert static electric energy into usable electromagnetic energy by oscillating a 710 DC energy source in series with a 712 LC circuit.

The 710 oscillating device (H bridge inverter) oscillates the 710 DC energy source in series with 712 LC circuit will circulate the potential back and forth between the poles, this oscillating returns reconditioned potential to the corresponding correct pole of the 710 source while creating “an active oscillating potential source” out of the 712a capacitor because the capacitor is never truly totally discharged, it is merely storing potential and switching the “potential” alternatively from positive to negative thus becoming an “energy source” which powers the circuit as a function of the frequency. The 712b inductor is also switching the polarity of the magnetic field, thus by definition converting electrical energy into an electromagnetic energy wave.

FIG. 7A (NEW ART) is a depiction of the frequency profile required to control the oscillation of the process of generating electromagnetic waves.

FIG. 8A and 8B are a graphical representation of the magnetic field of an inductor before and after doing work. FIG. 8A, in this example, the magnetic curl direction is clockwise and FIG. 8B, the magnetic curl direction is counter-clockwise thus demonstrating that the polarity of a magnetic field before and after doing work.

FIG. 9A and 9B demonstrate the change of polarity of a capacitor upon receiving electrical potential, the capacitor will reverse the polarity of the stored potential.

FIG. 9A shows that for a capacitor holding a negative charge upon receiving a positive DC pulse; it will produce a reversal of the electrical field to positive electrical field while it leaves the associated magnetic field polarity unchanged.

FIG. 9B shows that for a capacitor holding a positive charge upon receiving a negative DC pulse, it will produce a reversal of the electrical field to negative electrical field while it leaves the associated magnetic field polarity unchanged.

FIG. 10A and 10B demonstrate the reverse of polarity of the magnetic field upon inductors receiving electrical potential; the inductor will reverse the direction of rotation of the magnetic field doing work as shown on FIG. 8A and 8B. FIG. 10A depicts an inductor receiving negative potential doing “positive work” while FIG. 10B receives positive potential doing “negative work”.

FIG. 10A shows that for an inductor upon receiving a positive DC pulse, it will produce a reversal of the magnetic field from positive to negative magnetic field while it leaves the associated electric field polarity unchanged.

FIG. 10B shows that for an inductor upon receiving a negative DC pulse, it will produce a reversal of the magnetic field from negative to positive magnetic field while it leaves the associated electric field polarity unchanged

FIG. 11A and 11B demonstrate changes effected by an LC circuit when receiving an electrical potential pulse; the LC circuit will reverse the polarity of the magnetic and the electrical field together to match to have matching reversed polarity.

In the case of an LC circuit being oscillated by an AC potential at high frequency, the LC circuit will be alternatively doing “positive work” which requires energy and “negative work” which furnishes energy thus defining a method which exhibits a net zero energy change work process while the LC circuit will be reversing both the electrical and the magnetic field polarity of the returned potential to match. Matching polarity will not discharge the source.

FIG. 11A shows that for an LC upon receiving a negative DC pulse will produce a positive polarity reversal of both the magnetic field and the associated electric field thus by default re-conditioning of the returned potential to the receiving positive pole of the source.

FIG. 11B shows that for an LC upon receiving a positive DC pulse will produce a negative polarity reversal of both the magnetic field and the associated electric field thus by default re-conditioning of the returned potential to the receiving negative pole of the source .Thus becoming an alternating positive and negative work process which will yield net a zero energy change usage which does not violate the Second law of thermodynamics.

FIG. 12 (NEW ART) depicts the 1212 Electrical transformer, this device when used with cold potential is the key device on the production of electrical potential and it becomes a self-sustaining electrical generator.

The 1212 Electrical transformer functions as a three (3) channel electromagnetic energy wave splitter device as well as a two channel generator of cold potential. The 1210 Electrical transformer receives cold potential electromagnetic energy waves thru A-B connection as 1210 Cold potential Electromagnetic energy input and exports same 1202b Induced cold potential EM energy wave thru C-D connection as 1230 Generated electrical potential (when properly converted, see FIG. 13) while simultaneously exports 1202a Induced cold potential EM energy wave thru A-C connection as 1240 Generated electrical potential. The total voltage output at A-C is equivalent to the summation of the voltage input(A-B) plus the voltage output(C-D) as a function of the number of turns of the primary coil plus the number of turns of the secondary coil (proper transformer polarity must be observed).

Because the “mutual induction” developed between the primary and secondary coils, the transformer becomes an electrical generator. Given the usage of the proper devices to convert and recover the electrical potential (See FIG. 13); the electrical transformer is able to deliver electrical potential to power itself as well as power external loads.

The 1212 Electrical transformer with the respective LC circuits plays a major role in the generation of cold potential as well as the routing of the cold potential electromagnetic energy wave to power the loads while simultaneously allowing the continuing flow of the electromagnetic energy wave as a continuing loop which is required to maintain a zero entropy of the circuit as a closed loop system. The electrical transformer also plays a major role of maintaining the circuit “closed loop” negentropy integrity flow of the circuit, the increasing of the voltage output while allowing the delivering of work potential out.

FIG. 13 (NEW ART) shows the 1305 Electrical energy recovery module converts the cold potential electromagnetic energy wave bask to electrical DC potential as well as recovers electrical energy to power the 1340 Dc motor load.

The 1305 Electrical energy recovery module is made out of at least one 1332 capacitor in series with the secondary coil of the 1322 Electrical transformer and connected to 1320 Full wave rectifying device which uses diodes and which output is in series with the 1341 Battery and 1340 DC motor.

The 1305 Electrical energy recovery module interfaces with the 1322 Electrical transformer where it collects the exported inductive electromagnetic energy wave thru connection A-C and converts it to 1310 Generated DC potential to complete the entropic cycle. The 1305 Electrical energy recovery module is made out a dioded full wave rectifier and a capacitors set which convert the electromagnetic energy waves to electrical potential to maintain the negentropy integrity of the system.

FIG. 13 includes a 1328 Locked rotor safety to protect the inverter from a locked rotor energy feedback wave.

FIG. 14(NEW ART) depicts the 1400 Basic electric energy to electromagnetic energy wave convertor unit driven by an 1401 AC source for which the AC can be 1427a as a solar source, 1427b as wind or 1427c as common commercially available AC.

The main significance of this application is the fact that electrical potential of the source “is not consumed” when utilizing the “cold potential method” and under the assumption that the AC source is provided by a “common coal burning plant” which is providing the AC power, the energy utilization of such application does not use or consume electrical energy because under the practices of the “cold potential method” the electrical potential will not become an electrical load(resistance) to the remote generation process other than the resistance of transmission from the remote generating station to the user but “not hot amps” are required to extract cold potential thus extensive savings of fuel burning is obtained as well as great minimizing of the pollution associated with such practices will be attained. Under the cold potential method of this patent, the magnetic energy wave potential becomes the consumable not the electrical potential thus conserving on fuel. (The inventor not claiming the rights in this patent of such disclosure, reserves the rights of such application and practice for a future patent application).

The 1400 Basic electromagnetic convertor is made out of a 1401 AC source, 1450a capacitor, 1411 Electrical transformer connected to a 1425 Electrical potential recovery module, feeding an 1440 Electrical load and a 1430 Motor load.

FIGS. 15A and 15B represent two types of electronic oscillators inverters which can be used to convert the DC energy source to high frequency (AC) alternating current. The oscillator is generally driven by a separate signal generator shown as per FIG. 15A1. FIG. 15A1 is specifically designed to oscillate H Bridge applications.

FIGS. 16A thru 16C are sample circuit applications to practice the art. Generically speaking there are basically two types of applications for the oscillator-LC circuit, they are: (a) Constant frequency output applications and (b) Variable frequency output applications, these applications are simply variations of simple electrical transformer application with a primary and secondary coils and more complex transformers such as center tap transformer types.

FIG. 17 depicts the application of the art for a three (3) phase device.

### Controllability of the Circuit

There are innumerable oscillating-LC resonant circuits with non-resonant combinations and configurations available to practice the art including methods to supplement the Cold potential method, resonance is not a necessary requirement for the making of electro-magnetic waves. Some applications may include supplemental parallel tank LC circuits working in series with a main LC circuit which meets and fulfills the intent of the patent as a more efficient application for providing electrical charge potential.

This patent contemplates in subject that there are far many combinations of LC circuits to detail and enumerate herein, they are innumerable combinations of series and parallel resonant tank LC application which can extend and supplement the requirement to produce electromagnetic energy waves.

### TECHNICAL FIELD

This patent relates to the methods and devices used to harvest potential from DC energy sources(or AC energy converted to DC) by transforming DC electrical potential into an electromagnetic energy waves using electrical inductors and capacitors (LC circuit in series) which provide both a method to transmit and power an electrical load such as a motor as well as providing the method to reclaim the used potential to be re-used by the circuit.

The method utilizes a closed-loop negentropic process where the-a single converter alone or two different electromagnetic wave producing circuits ( A and B) having the capabilities of producing “charge potential” various frequencies can operate back to back as two entities or circuits to produce charging potential which can be used to produce work potential as well as recovering the energy in a round feeding mode between two electromagnetic energy converters back to back producing electromagnetic energy to maintain the energy sources without discharge.

The methods and devices are applicable to DC (shown) motors as well as AC systems. Fundamentally the patent deals with the generation and utilization of DC potential without seed source potential consumption by conversion of electrical energy into electromagnetic energy which can produce usable work where an electrical transformer becomes a motionless electrical generator thru the exposure to electromagnetic energy waves produced by a LC circuit in series with the said oscillating electrical energy source .

### Technical Problem

There is a need for an electromagnetic converter device which generates potential from energy sources which power devices and reclaims the potential for re-use to power electrical devices such as batteries, electrical motors and other electrical or electronic devices without discharging the source.

The primarily problem being addressed is the present waste of fuels and potential to produce electrical energy by our present electrical systems which shunts the source at the onset and destroys the potential of DC energy sources. Our present electrical systems do not utilize the magnetic portion of energy and operate in a “shorting mode” thus continually discharging the source and wasting the source's potential.

### Solution to Problem

The solution of the electrical energy waste consumption requires conversion and utilization of the electrical energy to electro-magnetic energy waves which allows for the use of the potential as an electrical and magnetic solution as well as the reconditioning of the potential means thus charging the source instead of discharging it. Electromagnetic energy waves provide by default the pure means of using and reclaiming the electrical potential as a closed loop reversible negentropic process.

Electromagnetic energy waves are produced from electrical energy by at least one LC circuit in series with a high frequency oscillating DC source by a bridge oscillator (such as an oscillating full wave H bridge inverter or equal).

Work potential in the form of generated electrical potential can be produced using electromagnetic energy waves and can be extracted and it is produced as a method of reconciling the internal kinetic energy of the system as a net zero energy change work process which does not discharge the source.

Because the methods and apparatus discussed by this patent are scalable, it provides the opportunity for scalable electromagnetic energy waves systems of virtually any size that can power electrically our homes, air condition and heat our homes by using the same techniques to power electric induction units , provide energy to power induction heat units to prepare and cook food, procure clean energy for transportation means for electric cars, trains and other methods as well as the development of twenty four hour energy lighting systems that can help humanity to raise food as well as the conversion of sea water to drinkable water and the extraction of drinkable water from the moisture contained in air in the desserts.

The overall methods and apparatus exposed by this patent shows clearly the discovery that “electrical energy” is better utilized if it is first converted to electromagnetic energy and then used to do usable work because it allows the reclaiming of potential for re-use.

Electrical energy today is presently being miss-applied as an incomplete half energy. Our electrical systems today use electrical energy in a hard form that is applied until depleted, this patent demonstrates that the electrical energy is better utilized if first transformed to “electromagnetic energy” and thus allowing for its reclamation for re-use.

The local utilization of electrical energy in the form of electromagnetic energy is a more efficient method of utilizing the electrical energy(both AC and DC electrical energy).

What is claimed:

1) (Independent claim/Currently amended) The EM link device which generates electromagnetic energy waves and radiates inductive magnetic waves comprised of:
An electrical source (DC or AC converted to DC),
a variable frequency oscillator inverter which oscillates the DC source,
an electrical transformer having at least one primary and secondary coil which may be a centered tap transformer type a series primary LC circuit made out of at least one capacitor and at least one primary inductor member device made out of the primary coil of the transformer,
forming a device which reconditions and recovers the electrical energy portion of the electromagnetic energy wave to recharge its own energy source thru a net zero energy change process while simultaneously exporting Displacement current cold electromagnetic radiant energy wave via the primary coil inductor member to the secondary coil of the transformer.

2) The net zero energy change work process and method of claim 1 which uses an alternating electromagnetic energy wave circuit with a series LC circuit which produces usable work potential in the form of a electromagnetic energy wave derived from the alternating “positive and negative work” production which yields the net zero energy change work process which does not discharge the source by recovering the electrical energy portion of the electromagnetic energy while exporting an inductive magnetic wave via the inductor member.

3) The cold potential electromagnetic energy wave generator apparatus made out of at least one EM link and the secondary coil of the common transformer of claim 1 which receives inductively electromagnetic energy wave from the transformer's primary coil and regenerates an electromagnetic energy wave (EM) generating additional electrical potential which encompasses altogether the minimum elements of:
An electrical source (DC or AC converted to DC) of claim 1, a variable frequency oscillator inverter which oscillates the DC source of claim 1,
the electrical transformer of claim 1 having at least one primary and secondary coil,
the series primary LC circuit made out of at least one capacitor and at least one primary inductor member device made out of a primary coil of a transformer of claim 1,
and an electronic electromagnetic wave converter plug made out of-rectifying diodes and capacitors,
where the primary LC circuit made of a capacitor and the transformer primary coil are connected in series and exports inductively EM energy to the second coil of the transformer,
where the secondary coil of the transformer, which receives a magnetic EM wave from the primary coil, generates electrical potential and interfaces with an electronic electromagnetic wave converter plug made out of rectifying diodes and capacitors means which recovers the generated DC electrical energy into a separate battery in series with the load.

4) The apparatus and the method of using at least one converter units of claim 3 working back to back which allows the production, use and recovery of the electromagnetic energy waves from a cyclic reversible entropic closed loop circuit.

5) The electromagnetic cycling net zero entropy change entropic closed loop reversible method and apparatus which converts electrical energy to electromagnetic energy waves and vice-versa using an oscillating DC source at varying frequencies in series with an LC circuit, an electrical transformer and a EM diode and capacitor means electronic plug which generates electrical potential and recovers such electrical energy to recharge electrical batteries to maintain the integrity of the net zero entropy change process.

6) The electromagnetic cycling entropic closed loop reversible apparatus of claim 5 which allows the conversion of electrical energy to electromagnetic energy waves and vice-versa at varying frequencies to maintain the integrity of a net zero entropy process which includes a net zero energy change work process which does not violate the Second law of thermodynamics.

7) (canceled)

8) The method to generate usable cold potential currents utilizing electromagnetic energy waves which replaces the ohmnic current with cold Displacement currents generated by the electrical circuit containing capacitors in series exposed to high frequency AC oscillating at varying frequencies which converts DC electrical energy to usable electromagnetic energy waves using a common transformer which exports electromagnetic energy wave (EM) to produce usable work yielding a reformatted electromagnetic energy wave(EM) which contains additional electrical potential.

9) The method to generate electrical potential of claim 3 by producing electromagnetic energy waves, recovering the electrical portion of the electromagnetic energy wave and transmitting the magnetic energy portion of the wave to form a new reformatted electromagnetic energy wave(EM) which contains additional electrical potential to power the load in a net zero energy work process fashion which does not discharge the source potential and does not violate the Second law of Thermodynamics.

10) (canceled)

11) The electromagnetic wave generator device made out of at least one electromagnetic energy wave converters of claim 3 which converts electrical energy to electromagnetic wave energy and vice-versa comprised of at least an oscillating energy source, an H bridge or equal inverter, an LC circuit made out of at least one inductor and one capacitor, an electrical transformer and a charging plug made out of a dioded means with capacitors which recovers the magnetic energy to charge another source while maintaining the closed loop entropy integrity required to maintain a net zero entropy change in the circuit.

12) (canceled)

13) (canceled)

14) (canceled)

15) (canceled)

16) (canceled)

17) The method of extracting electrical potential from at least one electromagnetic wave converters of claim 3 back to back in parallel which allows the circulating of the electromagnetic potential in a circular manner which allows the extraction of potential thru “a time-varying current rate of change” induced electromagnetic wave.

18) The entropic method of extracting usable electrical potential from magnetic energy to keep its batteries charged from at least one electromagnetic wave converter of claim 3 back to back in a circular fashion which allows the circulating of the potential in a closed loop manner which allows the extraction of potential thru “a time-varying current rate of change” at varying frequencies which produces a net zero energy change on the entire process.

19) (canceled)

20) (canceled)

21) The method of generating electrical potential of claim 3 by using an electrical transformer exposed to an oscillating electrical source in series with an LC circuit which produces an electromagnetic energy wave (EM) on the primary coil side and generates electrical potential on the secondary coil as a function of the magnetically induced electromagnetic energy wave.

22) The method used to recondition the potential of the oscillating source of claim 1 by using a capacitor and inductor in series which changes the polarity of the electrical and the magnetic energy flux to match the polarity of the destination pole which maintains the source charged.

23) The method to recover the electrical potential of the primary LC circuit of claim 1 which uses at least one capacitor, an inductor and an oscillating source operating ideally at near resonance high frequency to maintain its energy source charged by returning reconditioned potential with electric and magnetic field polarity matching the receiving pole polarity.

24) The cold potential generator of claim 1 which produces magnetic energy potential fueled by the produced electromagnetic energy waves by separating the magnetic energy from the electrical energy portion of the primary electromagnetic energy waves which becomes a source of inductive magnetic potential which generates a reformatted EM wave which generates additional electrical potential to recharge electrical battery sources to maintain miscellaneous work processes.

25) The method of generating cold magnetic wave radiation of the device in claim 3 which generates cold radiant electromagnetic waves which generates electrical potential that can be converted into electrical potential using in conjunction with an energy source.

26) The method of claim 3 of converting electrical AC potential using electromagnetic energy waves which uses only electrical potential without being a direct ohmnic current burden to the source to generate additional electrical DC potential to charge batteries which can be used to motivate induction motors.

27) The method of increasing the output charging capacity of the device in claim 1 by increasing the oscillating frequency.
